(19) United States
(12) Patent Application Publication
(10) Pub. No.: US 2006/0187997 A1
(43) Pub. Date: Aug. 24, 2006

(54) Vertical cavity surface emitting laser diode

(75) Inventors: Mizunori Ezaki, Yokohama-Shi (JP); Mitsuhiro Kushibe, Tokyo (JP); Michihiko Nishigaki, Kawasaki-Shi (JP); Keiji Takaoka, Kawasaki-Shi (JP)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/332,043

(22) Filed: Jan. 13, 2006

(30) Foreign Application Priority Data
Jan. 17, 2005 (JP) 2005-9092

(51) Int. Cl. H01S 3/08

(52) U.S. Cl. 372/99

(57) ABSTRACT

It is made possible to obtain high performance having high controllability in polarization mode even when a vertical cavity surface emitting laser diode is fabricated on an ordinary substrate with a plane orientation (100) plane or the like. A vertical cavity surface emitting laser diode includes: a substrate; a semiconductor active layer which is formed on the substrate and has a light emitting region; a first reflecting mirror and a second reflecting mirror sandwiching the semiconductor active layer; a first recess which has a first groove depth penetrating at least the semiconductor active layer from the outermost layer of the first reflecting mirror; a second recess having a second groove depth shallower than the first groove depth; a mesa portion which is surrounded by the first and second recesses; and an insulating film which is buried in the first recess.

### CROSS-REFERENCE TO RELATED APPLICATION

This application is based upon and claims the benefit of priority from prior Japanese Patent Application No. 2005-9092 filed on Jan. 17, 2005 in Japan, the entire contents of which are incorporated herein by reference.

### BACKGROUND OF THE INVENTION

1. Field of the Invention

The present invention relates to a vertical cavity surface emitting laser (VCSEL) diode.

2. Related Art

Semiconductor light emitting devices such as a laser diode or a semiconductor light emitting diode have been broadly used in not only an optical communication field but also such an optical disk system as a CD (compact disc) or a DVD (digital versatile disc), or a barcode reader. When the semiconductor light emitting devices are used in various application fields including such an optical communication field, it becomes important to unitize operation modes regarding three modes of “longitudinal mode”, “transverse mode”, and “polarization mode” present in the laser diode. Currently, an end face light emitting laser diode is stable in the polarization mode where fluctuation does not occur. This is because an optical cavity is constituted of a waveguide in the end face light emitting laser diode, TM (transverse magnetic) wave is larger in reflectivity at a waveguide end face than TE (transverse electric) wave, and an electric vector oscillates at TE wave in a direction parallel to a semiconductor substrate. In the longitudinal mode, unitizing can be also realized by taking in a distributed feedback structure, and in the transverse mode, unitizing can be achieved in the end face light emitting laser diode by adopting a narrow stripe structure.

On the other hand, in a vertical cavity surface emitting laser diode, since an optical cavity thereof is very short, a single mode behavior occurs in the longitudinal mode, and a single mode behavior is also made possible regarding the transverse mode by a technique such as fining of an active region based upon a current narrowing structure obtained by selective oxidation of an aluminum (Al) high concentration layer or proton implantation.

As regards the polarization mode, however, it is difficult to make control on a polarization direction in the vertical cavity surface emitting laser diode, as compared with the end face emitting laser diode. This is due to symmetry in (100) plane substrate used for manufacturing an ordinary vertical cavity surface emitting laser diode or a device structure itself, and because linear polarization can be obtained but there is no gain difference between orthogonal polarized waves in the active region itself and it is difficult to perform such measure as increasing a reflectivity of a reflecting mirror to a polarized wave in a specific orientation. Therefore, switching in a polarization direction occurs easily due to a fine change of external conditions such as a temperature or a driving current, so that the polarization mode greatly influences magnetooptical recording or coherent communication utilizing polarization of laser, or the like. Even when ordinary data communication is performed, instability of the polarization mode causes over-noise mode competition and also causes such a problem as increase in error or limitation in transmission band. Therefore, control (stabilizing) of the polarization mode is an important problem to be solved in order to achieve actual application of the vertical cavity surface emitting laser diode.

Since importance of the polarization control was indicated, there are the following conventional approaches,

(1) Structure where metal dielectric diffraction grating is assembled in a reflecting mirror formed of a semiconductor multi-layer,

(2) Structure where asymmetry is taken in a mesa shape of a device,

(3) Manufacturing on an inclined substrate, and

(4) Structure where an insulating layer is provided to contact with an outer face of a column portion which is one portion of an optical cavity.

The approach (1) of the four approaches is a method where fine metal wires are arranged on a reflecting mirror made of a semiconductor multi-layer in a fixed direction and the reflectivity of the mirror for a polarized wave in a specific orientation is increased. Since the reflectivity of the mirror to polarized lights parallel to the metal wires becomes high, it is effective for stabilizing a polarization plane to some extent, but there is difficulty in manufacture because it is necessary to form metal wires with a width equal to or less than a light wavelength.

The approach (2) where the asymmetry is taken in a mesa shape of a device is disclosed in Japanese Patent Laid-Open Publication (JP-A) No. 11-54838, for example. In JP-A-11-54838, stress is applied to an active layer around a mesa center in non-isotropic (anisotropic) manner by providing a stress-applying region around a mesa so that strain or strain is generated in anisotropic manner. A gain difference between orthogonal polarized waves occurs due to such strain, so that only a polarized wave in a specific direction becomes preferential and polarization controllability becomes high.

Similarly, adding a T-shaped projection to a cylindrical mesa structure is described in IEEE Photon. Technol. Lett. Vol. 14, No. 8, 1034 (2002). An entire Al high concentration layer (Al_{0.9}Ga_{0.1}As layer) of a reflecting mirror made of a semiconductor multi-layer at the T-shaped fine wire portion is oxidized by a selective oxidizing process, and anisotropic strain is applied to an active layer positioned at the mesa center by strong stress generated due to volume shrinkage, so that polarization controllability is enhanced.

In IEEE Photon. Technol. Lett. Vol. 6, No. 1, 40 (1994), adopting a dumbbell type mesa structure to make current injection to an active layer asymmetrical thereby achieving polarization control is described. The stress (strain)-applying region or the asymmetrical mesa structure includes such a problem that device processing is complicated, and device productivity, plane reproducibility, and polarization controllability become insufficient like the above approach (1).

On the other hand, the approach (3) using an inclined substrate utilizes that an active layer is formed on a high index orientation crystal plane such as a (311) A plane or a (311) B plane in order to increase gain to polarization in a certain orientation and the gain depends on the crystal orientation. In the approach, strong extinction ratio can be obtained, where controllability in the polarization mode is excellent. However, the approach (3) includes such a problem that it is difficult to obtain crystal growth with excellent quality and it is difficult to achieve high output, which is different from an approach utilizing an ordinary (100) plane. In the vertical cavity surface emitting laser diode adopting the selective oxidizing system on an inclined substrate, strain occurs in oxidization (light emitting region) shape due to difference in oxidation rate among crystal plane orientations, which results in difficulty in beam shape control.

The approach (4) where an insulating layer is provided so as to contact with an outer face of a column portion is disclosed in JP-A-2001-189525. A structure described in JP-A-2001-189525 is for performing control on a polarization direction of laser beam by anisotropic stress due to a plane shape of the insulating layer. However, the polarization direction of laser beam can not be controlled sufficiently by utilizing only the stress due to the plane shape of the insulating layer described in JP-A-2001-189525.

The vertical cavity surface emitting laser diode has many merits such that a threshold is low, power consumption is low, a light emitting efficiency is high, high-speed modulation is made possible, beam spreading is small so that coupling with an optical fiber is easy, end face cleavage is not required so that mass productivity is excellent, except for the problem about the polarization mode control. Further, since many laser devices can be integrated on a substrate in a two-dimensional manner, the vertical cavity surface emitting laser diode get a lot of visibility as a key device in an optical electronics field in a fast optical LAN (local area network), an optical interconnector, or the like. Accordingly, there is a strong demand for solution of the outstanding problems described above and development of a vertical cavity surface emitting laser diode whose polarization controllability is improved and which is excellent in mass productivity.

As described above, in the vertical cavity surface emitting laser diode manufactured on a ordinary substrate with a plane orientation (100) plane or the like, there is such a difficult problem that there is not gain difference between orthogonal polarized waves in an active layer and switching of polarization direction occurs easy due to symmetry of a crystal structure so that it is difficult to control the polarization mode.

### SUMMARY OF THE INVENTION

The present invention has been made in view of these circumstances and an object thereof is to provide a vertical cavity surface emitting laser diode with high performance where controllability in polarization mode and/or mass productivity are high, even if the vertical cavity surface emitting laser diode is manufactured on an ordinary substrate with a plane orientation (100) plane or the like.

A vertical cavity surface emitting laser diode according to a first aspect of the present invention includes: a substrate; a semiconductor active layer which is formed on the substrate and has a light emitting region; a first reflecting mirror and a second reflecting mirror which sandwich the semiconductor active layer to form an optical cavity in a direction perpendicular to the substrate, the first reflecting mirror having a first semiconductor multi-layer film and being formed on an opposite side of the semiconductor active layer from the substrate, and the second reflecting mirror having a second semiconductor multi-layer and being formed on a side of the substrate to the semiconductor active layer; a pair of electrodes configured to inject current into the semiconductor active layer; a first recess which has a first groove depth penetrating at least the semiconductor active layer from the outermost layer of the first reflecting mirror; a second recess having a second groove depth shallower than the first groove depth; a mesa portion which is surrounded by the first and second recesses; and an insulating film which is buried in the first recess.

A vertical cavity surface emitting laser diode according to a second aspect of the present invention includes: a substrate; a semiconductor active layer which is formed on the substrate and has a light emitting region; a first reflecting mirror and a second reflecting mirror which sandwich the semiconductor active layer to form an optical cavity in a direction perpendicular to the substrate, the first reflecting mirror having a first semiconductor multi-layer film and being formed on an opposite side of the semiconductor active layer from the substrate, and the second reflecting mirror having a second semiconductor multi-layer and being formed on a side of the substrate to the semiconductor active layer; a pair of electrodes configured to inject current into the semiconductor active layer; a first recess which has a first groove depth penetrating at least the semiconductor active layer from the outermost layer of the first reflecting mirror; a second recess which has a second groove depth substantially equal to the first groove depth and has a size smaller than that of the first recess; a mesa portion which is surrounded by the first and second recesses; and an insulating film which is buried in the first recess.

The insulating film can be also buried in the second recess.

The vertical cavity surface emitting laser diode can further include a current confinement portion which is formed between the first reflecting mirror and the second reflecting mirror, and has a first to-be-oxidized layer including Al, side portions of the first to-be-oxidized layer being oxidized and a central portion thereof being non-oxidized.

The first to-be-oxidized layer of the current confinement portion can be different in size of an oxidized region between a direction in which the first recess is provided and a direction in which the second recess is provided.

The first to-be-oxidized layer can be formed on the side of the substrate to the semiconductor active layer.

The first to-be-oxidized layer can be formed on the opposite side of the semiconductor active layer from the substrate.

The current confinement portion can further include a second to-be-oxidized layer which includes Al and is formed on the side of the substrate to the semiconductor active layer.

A central portion of the second to-be-oxidized layer can be non-oxidized and side portions thereof are oxidized.

The mesa portion can be provided in the first reflecting mirror with a proton implantation region.

The insulating film can be made from material having a thermal expansion coefficient larger than those of the substrate, the first and second reflecting mirrors, and the semiconductor active layer.

The insulating film can be made from polyimide resin.

The semiconductor active layer can be made from semiconductor material including Ga, IN, and at least one of As and N.

In this text, the term “a to-be-oxidized layer” means a layer which should be oxidized, but the term is defined to include a state of a layer before oxidized and a state thereof after oxidized.

### BRIEF DESCRIPTION OF THE DRAWINGS

FIG. 1 is a plan view of a vertical cavity surface emitting laser diode according to a first embodiment of the present invention;

FIG. 2 is a sectional view of the vertical cavity surface emitting laser diode taken along line A-A′ shown in FIG. 1;

FIG. 3 is a sectional view of the vertical cavity surface emitting laser diode taken along line B-B′ shown in FIG. 1;

FIG. 4 is a view showing a shape of an oxidized region of an upper to-be-oxidized layer of the vertical cavity surface emitting laser diode according to the first embodiment obtained when the vertical cavity surface emitting laser diode has been cut at a height thereof;

FIG. 5 is a sectional view of the vertical cavity surface emitting laser diode taken along line A-A′ shown in FIG. 4;

FIG. 6 is a sectional view of the vertical cavity surface emitting laser diode taken along line B-B′ shown in FIG. 4;

FIG. 7 is a view showing a shape of an oxidized region of a lower to-be-oxidized layer of the vertical cavity surface emitting laser diode according to the first embodiment obtained which has been cut at another height thereof;

FIG. 8 is a sectional view of the vertical cavity surface emitting laser diode taken along line A-A′ shown in FIG. 7;

FIG. 9 is a sectional view of the vertical cavity surface emitting laser diode taken along line B-B′ shown in FIG. 7;

FIG. 10 is a view showing a shape of an oxidized region of an upper to-be-oxidized layer of a vertical cavity surface emitting laser diode according to a first modification of the first embodiment obtained which has been cut at a height thereof;

FIG. 11 is a sectional view of the vertical cavity surface emitting laser diode taken along line A-A′ shown in FIG. 10;

FIG. 12 is a sectional view of the vertical cavity surface emitting laser diode taken along line B-B′ shown in FIG. 10;

FIG. 13 is a view showing a shape of an oxidized region of an upper to-be-oxidized layer of a vertical cavity surface emitting laser diode according to a second modification of the first embodiment obtained which has been cut at a height thereof;

FIG. 14 is a sectional view of the vertical cavity surface emitting laser diode taken along line A-A′ shown in FIG. 13;

FIG. 15 is a sectional view of the vertical cavity surface emitting laser diode taken along line B-B′ shown in FIG. 13;

FIG. 16 is a plan view of a vertical cavity surface emitting laser diode according to a second embodiment of the present invention;

FIG. 17 is a sectional view of the vertical cavity surface emitting laser diode taken along line A-A′ shown in FIG. 16;

FIG. 18 is a sectional view of the vertical cavity surface emitting laser diode taken along line B-B′ shown in FIG. 16;

FIG. 19 is a view showing a shape of an oxidized region of a semiconductor multi-layer reflecting mirror of a vertical cavity surface emitting laser diode according to the second embodiment when the vertical cavity surface emitting laser diode has been cut at a height thereof and a shape of an oxidized region of an upper to-be-oxidized layer obtained when the vertical cavity surface emitting laser diode has been cut at another height thereof in a superimposing manner;

FIG. 20 is a sectional view of the vertical cavity surface emitting laser diode taken along line A-A′ shown in FIG. 19;

FIG. 21 is a sectional view of the vertical cavity surface emitting laser diode taken along line B-B′ shown in FIG. 19;

FIG. 22 is a view showing a shape of an oxidized region of an upper to-be-oxidized layer obtained when the vertical cavity surface emitting laser diode according to the second embodiment has been cut at a height thereof and a shape of the oxidized region of the semiconductor multi-layer reflecting mirror obtained when the vertical cavity surface emitting laser diode has been cut at another height thereof in a superimposing manner;

FIG. 23 is a sectional view of the vertical cavity surface emitting laser diode taken along line A-A′ shown in FIG. 22;

FIG. 24 is a sectional view of the vertical cavity surface emitting laser diode taken along line B-B′ shown in FIG. 22;

FIG. 25 is a plan view of a vertical cavity surface emitting laser diode according to a third embodiment of the present invention;

FIG. 26 is a sectional view of the vertical cavity surface emitting laser diode taken along line A-A′ shown in FIG. 25;

FIG. 27 is a sectional view of the vertical cavity surface emitting laser diode taken along line B-B′ shown in FIG. 25;

FIG. 28 is a view showing a shape of an oxidized region of a semiconductor multi-layer reflecting mirror of a vertical cavity surface emitting laser diode according to the third embodiment obtained when the vertical cavity surface emitting laser diode has been cut at a height thereof and a shape of an oxidized region of an upper to-be-oxidized layer obtained when the vertical cavity surface emitting laser diode has been cut at another height thereof in a superimposing manner;

FIG. 29 is a sectional view of the vertical cavity surface emitting laser diode taken along line A-A′ shown in FIG. 28;

FIG. 30 is a sectional view of the vertical cavity surface emitting laser diode taken along line B-B′ shown in FIG. 28;

FIG. 31 is a plan view of a vertical cavity surface emitting laser diode according to a fourth embodiment of the present invention;

FIG. 32 is a sectional view of the vertical cavity surface emitting laser diode taken along line A-A′ shown in FIG. 31;

FIG. 33 is a sectional view of the vertical cavity surface emitting laser diode taken along line B-B′ shown in FIG. 31;

FIG. 34 is a view showing a shape of an oxidized region of a semiconductor multi-layer reflecting mirror of a vertical cavity surface emitting laser diode according to the fourth embodiment obtained when the vertical cavity surface emitting laser diode has been cut at a height thereof and a shape of an oxidized region of an upper to-be-oxidized layer obtained when the vertical cavity surface emitting laser diode has been cut at another height thereof in a superimposing manner;

FIG. 35 is a sectional view of the vertical cavity surface emitting laser diode taken along line A-A′ shown in FIG. 34;

FIG. 36 is a sectional view of the vertical cavity surface emitting laser diode taken along line B-B′ shown in FIG. 34;

FIG. 37 is a view showing a shape of an oxidized region of a lower to-be-oxidized layer obtained when the vertical cavity surface emitting laser diode according to the fourth embodiment has been cut at a height thereof and a shape of an oxidized region of a semiconductor multi-layer reflecting mirror obtained when the vertical cavity surface emitting laser diode has been cut at another height thereof;

FIG. 38 is a sectional view of the vertical cavity surface emitting laser diode taken along line A-A′ shown in FIG. 37;

FIG. 39 is a sectional view of the vertical cavity surface emitting laser diode taken along line B-B′ shown in FIG. 37;

FIGS. 40A and 40B are illustrative views showing non-oxidized regions on a (100) plane substrate and a 10°-off substrate, respectively;

FIG. 41 is a graph showing a dependency of an oxidizing rate of an AlGaAs layer on a proton concentration;

FIG. 42 is a plan view of a vertical cavity surface emitting laser diode according to a comparative example to the first embodiment;

FIG. 43 is a sectional view taken along line A-A′ shown in FIG. 42;

FIG. 44 is a sectional view taken along line B-B′ shown in FIG. 42;

FIG. 45 is a view showing a shape of an oxidized region of an upper to-be-oxidized layer obtained when a vertical cavity surface emitting laser diode of a comparative example has been cut at a height thereto;

FIG. 46 is a sectional view taken along line A-A′ shown in FIG. 45;

FIG. 47 is a sectional view taken along line B-B′ shown in FIG. 45.

### DETAILED DESCRIPTION OF THE INVENTION

Embodiments of the present invention will be explained below in detail with reference to the drawings.

### First Embodiment

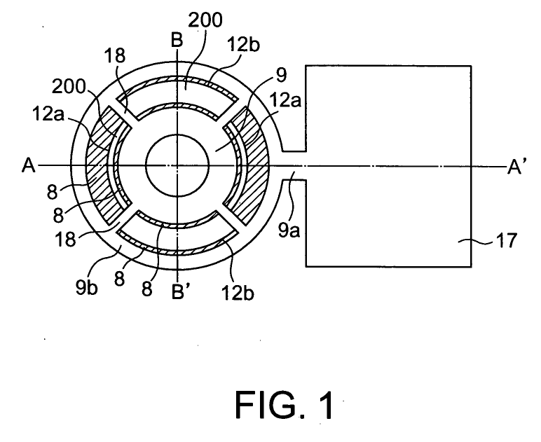

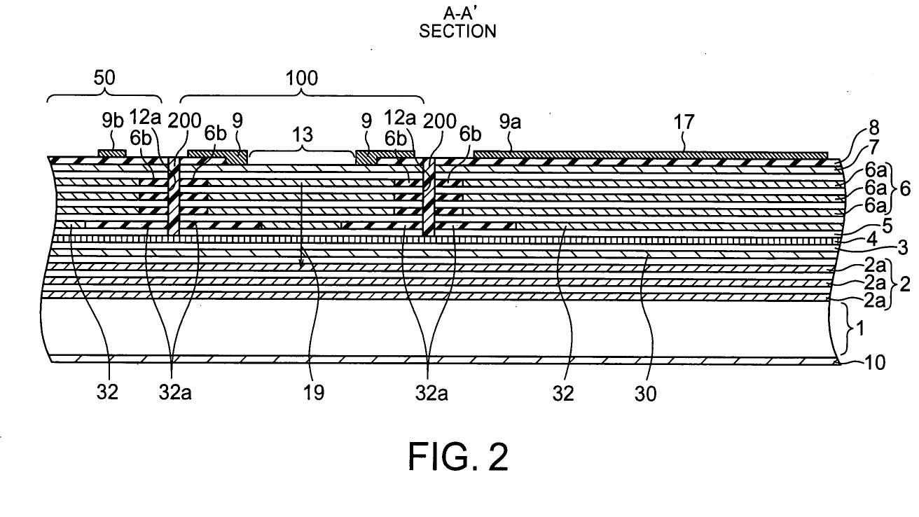

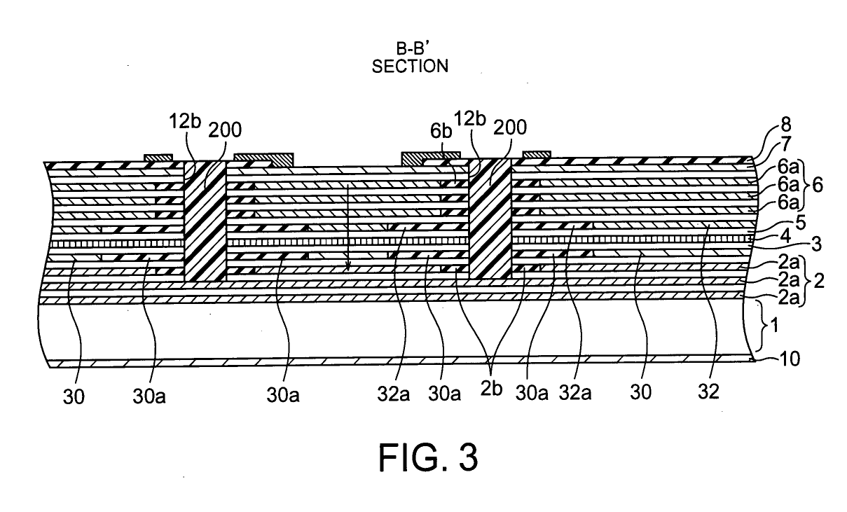

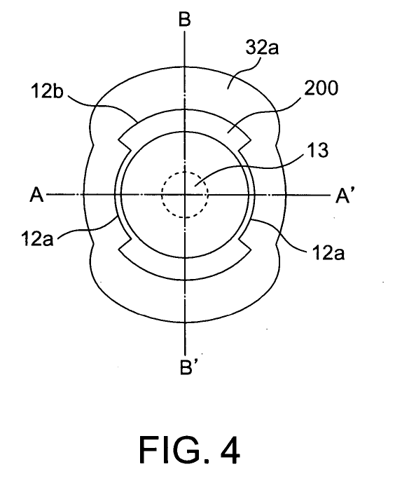

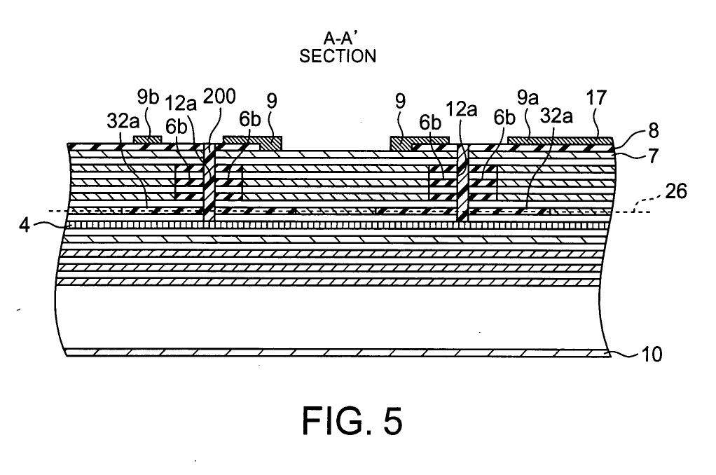

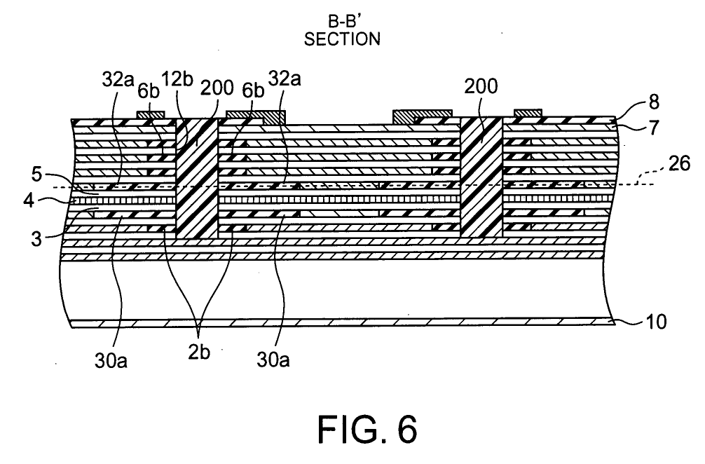

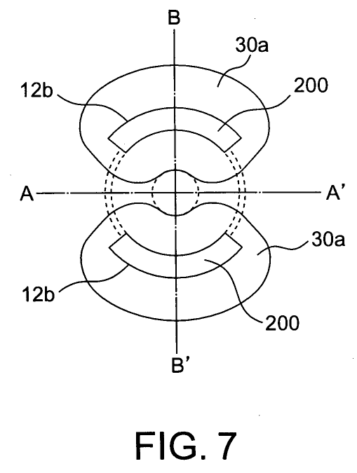

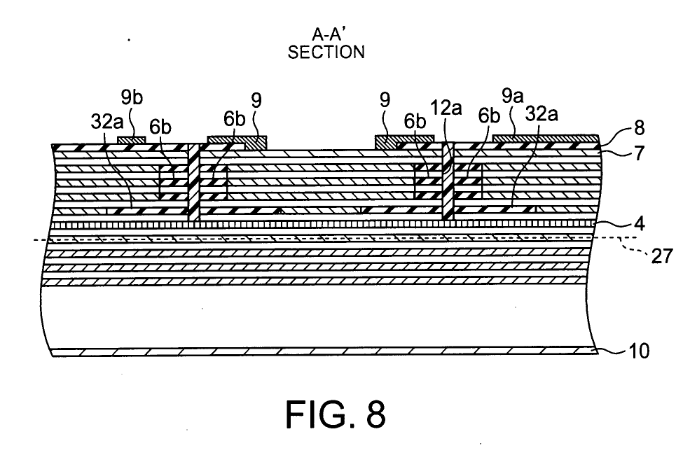

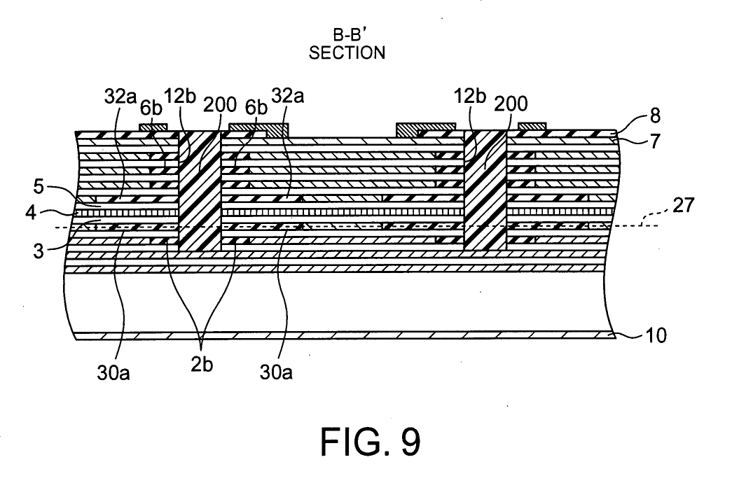

FIGS. 1 to 9 are illustrative views showing a structure of a vertical cavity surface emitting laser diode according to a first embodiment of the present invention. FIG. 1 is a plan view of the vertical cavity surface emitting laser diode, FIG. 2 is a sectional view of the vertical cavity surface emitting laser diode taken along A-A′ shown in FIG. 1, and FIG. 3 is a sectional view of the vertical cavity surface emitting laser diode taken along B-B′ shown in FIG. 1. FIG. 4 is a view showing a shape of an oxidized region 32a of an upper to-be-oxidized layer 32 obtained when the vertical cavity surface emitting laser diode has been cut at a height 26 thereof (see FIG. 5), FIG. 5 is a sectional view of the vertical cavity surface emitting laser diode taken along line A-A′ shown in FIG. 4, and FIG. 6 is a sectional view of the vertical cavity surface emitting laser diode taken along line B-B′ shown in FIG. 4. FIG. 7 is a view showing a shape of an oxidized layer of a lower to-be-oxidized layer 30 obtained when the vertical cavity surface emitting laser diode according to the embodiment has been cut at a height 27 thereof, FIG. 8 is a sectional view of the vertical cavity surface emitting laser diode taken along line A-A′ shown in FIG. 7, and FIG. 8 is a sectional view of the vertical cavity surface emitting laser diode taken along line B-B′ shown in FIG. 7.

The vertical cavity surface emitting laser diode according to the embodiment is a vertical cavity surface emitting semiconductor laser device. The vertical cavity surface emitting laser diode is provided on an ordinary substrate 1 with a plane orientation (100) plane with a semiconductor active layer 4 having a light emitting region 13, a first semiconductor multi-layer film reflecting mirror 6 formed above the semiconductor active layer 4, and a second semiconductor multi-layer film reflecting mirror 2. The semiconductor multi-layer layer film reflecting mirror 2 and the semiconductor multi-layer film reflecting mirror 6 constitute an optical cavity in a direction perpendicular to a main plane of the substrate 1. Semiconductor cladding layers 3 and 5 are respectively provided between the semiconductor active layer 4 and the reflecting mirror 2 and between the semiconductor active layer 4 and the reflecting mirror 6.

An upper layer to be oxidized 32 including aluminum (Al) at a high concentration is provided between the semiconductor multi-layer film reflecting mirror 6 and the cladding layer 5 and a lower to-be-oxidized layer 30 including aluminum (Al) at a high concentration is provided between the semiconductor multi-layer layer film reflecting mirror 2 and the cladding layer 3. As described later, the semiconductor multi-layer film reflecting mirrors 6 and 2 include Al high concentration layers 6a and 2a, respectively. The semiconductor multi-layer film reflecting mirrors 6, 2 and the to-be-oxidized layers 32, 30 have oxidized regions 6b, 2b and oxidized regions 32a, 30a which are formed by selective oxidation of a mesa portion 100 from a side wall thereof toward a light emitting region 13 laterally. A current confinement portion is formed by the oxidized regions 32a and 30a. Current 19 injected through an electrode 9 and an electrode 10 is confined to the light emitting region 13 by the current confinement portion.

A contact layer 7 is formed on the first semiconductor multi-layer film reflecting mirror 6, and the contact electrode 9 for injecting current into the light emitting region 13 is formed through the first semiconductor multi-layer film reflecting mirror 6 and the contact layer 7. The contact electrode 9 is formed so as to open an upper face of the light emitting region 13.

The electrode 10 is formed on a back face of the substrate 1, and current is injected into the light emitting region 13 through the second semiconductor multi-layer film reflecting mirror 2.

As shown in FIG. 2 which is a sectional view of the vertical cavity surface emitting laser diode taken along line A-A′ in FIG. 1, an etching region (recess) 12a is provided outside the mesa portion 100, and the etching regions 12a is filled with a filler film 200. A depth of the etching region 12a is adjusted such that side faces of the first semiconductor multi-layer film reflecting mirror 6, the upper to-be-oxidized layer 32, and the cladding layer 5 and a surface of the active layer 4 are exposed. Incidentally, the depth of the etching region 12a may be formed to reach at least an upper surface of the upper to-be-oxidized layer 32. On the other hand, as shown in FIG. 3 which is a sectional view of the vertical cavity surface emitting laser diode taken along line B-B′ in FIG. 1, an etching region (recess) 12b is provided outside the mesa portion 100. The etching region 12b may be formed though at least the lower to-be-oxidized layer 30. The etching region 12b is filled with a filler film 200. A depth of the etching region 12b is adjusted such that side faces of the first semiconductor multi-layer film reflecting mirror 6, the upper to-be-oxidized layer 32, the cladding layer 5, the active layer 4, the cladding layer 3, and the lower to-be-oxidized layer 30 are exposed and side faces of some layers (but not all layers) in the second semiconductor multi-layer film reflecting mirror 2 are exposed. As described later in detail, in the embodiment, by changing the numbers of layers in the oxidized region 32a and 30a between the line A-A′ direction and the line B-B′ direction, making the shapes of the oxidized regions asymmetric and burying the filler films 200 in the recesses 12a and 12b different in depth, anisotropic stress is applied to the active layer 4 so that high polarization controllability is realized.

A surrounding region 50 provided outside the etching regions 12a, 12b also has a stacked layer structure like the mesa portion 100. A surrounding electrode 9b is formed on the surrounding portion 50. A surface of the mesa portion 100 and a surface of the surrounding portion 50 have approximately the same height.

The contact electrode 9 and the surrounding electrode 9b are connected to each other via a wiring bus 18, and the surrounding electrode 9b and a bonding pad 17 are connected to each other through a wiring portion 9a. Incidentally, one portion of the wiring portion 9a is formed on the filler film 200. A protective film 8 made of, for example, a silicon nitride film, is properly provided on the contact layer 7.

Such a vertical cavity surface emitting laser diode can emit light by injecting current in the active layer 4 from the contact layer 9 through the semiconductor multi-layer film reflecting mirror 6 as shown by arrow 19.

Since the contact electrode 9, the surrounding electrode 9b, and a wiring path 18 connecting them are formed to have approximately the same level (height), the vertical cavity surface emitting laser diode has a structure that a planarization process is not required. Therefore, the vertical cavity surface emitting laser diode has such merit that “step breaking” of a wire can be prevented.

In the embodiment, as described above, the layer number of the oxidized regions is different between the line A-A′ direction and the line B-B′ direction. That is, as shown in FIGS. 1 to 3, the oxidized regions 6b and 32a are formed in only the first semiconductor multi-layer film reflecting layer 6 and the upper to-be-oxidized layer 32 in the line A-A′ direction, while the oxidized regions 6b, 32a, 30a, and 2b are formed in the upper to-be-oxidized layer 32, the lower to-be-oxidized layer 30, and a layer(s) in the second semiconductor multi-layer film reflecting mirror 2 in the line B-B′ direction, respectively. That is, the layer numbers of the oxidized regions in the line A-A′ direction and in the line B-B′ direction are different from each other.

As shown in FIGS. 4 to 6, in the vertical cavity surface emitting laser diode, the oxidized regions 32a and 30a of the upper to-be-oxidized layer 32 and the lower to-be-oxidized layer 30 in the line B-B′ direction and the oxidized region 32a of only the upper to-be-oxidized layer 32 in the line A-A′ direction are formed in asymmetrical manner.

In manufacturing a surface emitting laser diode utilizing a selective oxidizing system, when an AlGaAs (aluminum gallium arsenide) layer (it is desirable that a composition ratio of Al in III group element is 95% or more) which is a to-be-oxidized layer including an AlAs (aluminum arenide) or Al at a high concentration is vapor-oxidized, the to-be-oxidized layers 32 and 30, or only the to-be-oxidized layer 32 are oxidized, so that the current confinement portion is formed. Compression stress generated due to volume shrinkage according to the oxidation of the to-be-oxidized layers 32 and 30 acts on the semiconductor active layer 4 at a central portion of the mesa portion 100 at a large magnitude in the line B-B′ direction and at a small magnitude in the line A-A′ direction. That is, strain is applied to the active layer 4 in an anisotropic manner. When the oxidized layer Alₓ(Ga)O_{y} is formed, since volume shrinkage (about 10% to 13%) occurs as compared with the original Al(Ga)As layer, large compression stress in the order of Giga Pascal (GPa) is applied to the active layer 4 and the central portion of the mesa structure.

In the embodiment, by using, for example, polyimide resin as material for burying the filler films 200 in the etching regions 12a and 12b, asymmetry of the compression stress applied to the central portion of the semiconductor active layer 4 positioned at the center of the mesa portion 100 can be enhanced.

When AlAs is used as material for the to-be-oxidized layers 32 and 30, volume shrinkage due to oxidation is in a range of 12% to 13%, so that compression force F1 in a range of 1 GPa to 10 GPa per one to-be-oxidized layer occurs. Therefore, since compression force of F1 occurs in the A-A′ direction due to presence of only the upper layer and compression force of 2×F1 occurs in the B-B′ direction due to presence of the upper and lower layers, compression force applied on the active layer 4 is different among respective directions.

In order to perform current narrowing effectively, the to-be-oxidized layers 32 and 30 serving as a current blocking layer are each required to have a thickness to some extent, but strain to be applied increases according to increase in thickness of a layer or increase in number of layers. In addition, the strain is concentrated at a distal end of the oxidized region, and since the to-be-oxidized layers 32 and 30 are provided at close points of about 0.2 μm from the active layer 4, a region of the active layer 4 to which current is most concentrated is influenced. In the embodiment, asymmetry of stress application to the active layer 4 becomes large, so that polarization controllability is enhanced more effectively than the conventional art. When polyimide resin is used as material for burying in the recess, heat stress σ_{T} generated between the filler film 200 made from polyimide and the GaAs substrate 1 is expressed by the following equation
σ_{T}=E_{F}(α_{F}−α_{S})ΔT

Here, α_{F} is thermal expansion coefficient of polyimide, α_{S} is thermal expansion coefficient of the GaAs substrate 1, E_{F} is elastic coefficient of the filler film 200 made from polyimide, ΔT is temperature difference (T_{F}−T), T_{F} is glass-transition temperature of polyimide, and T is measured temperature.

When the glass-transition temperature T_{F} is 300° C. and the operation temperature T is 20° C., ΔT=280K is obtained. At that time, a compression stress (heat stress) of σT=54 Mta is generated in the filler film 200 made from polyimide (E_{F}=3 GPa, α_{F}=7×10⁻⁵/K) and the GaAs substrate 1 (α_{F}=6.0×10⁻⁶/K). Thereby, volumes of the filler film 200 filled in the recesses 12a and 12b are different for respective places, so that compression stress is applied in asymmetrical manner like the stress due to oxidation.

In the embodiment, the recesses 12a and 12b are different from each other in depth. That is, the depths of the filler film 200 in the line A-A′ direction and the line B-B′ direction are different from each other. In the embodiment, therefore, asymmetry of stress application to the active layer 4 is made larger than that in the case where plane shapes in respective directions are different but depths in the respective directions are the same, which is disclosed in JP-A-2001-189525, so that polarization controllability can be further enhanced.

The conventional device structure for achieving polarization control such as described in JP-A-11-54838 is a structure having a stress (strain) applying region about a portion surrounding a mesa. On the other hand, in the embodiment, the stress (strain) acting region is positioned at the center of the mesa portion 100, and a structure where the stress acting region is positioned closest to the semiconductor active layer 4 is adopted. Stress applied to a semiconductor active layer decreases in reverse proportion to a distance between the stress (strain) adding region and the active layer. Therefore, in the structure where the stress (strain) applying region is positioned closest to the active layer according to the embodiment, polarization controllability is improved, as compared with the conventional case.

When film stresses in respective layers grown on the substrate are present, since etching volumes of recess in the line A-A′ direction and in the line B-B′ direction are different from each other in the etching regions 12a and 12b for forming the mesa portion 100, compression stress or tensile stress is applied to the semiconductor active layer 4 in an asymmetrical manner in a horizontal direction to a substrate plane so that the polarization controllability is further enhanced.

In a vertical cavity surface emitting laser diode on an ordinary substrate, it is possible to suppress distortion of a shape of the current confinement portion due to anisotropic oxidation, which becomes significant in an inclined substrate, in the selective oxidation.

As explained above, according to the embodiment, the polarization controllability is enhanced, so that a vertical cavity surface emitting laser diode with high performance can be obtained.

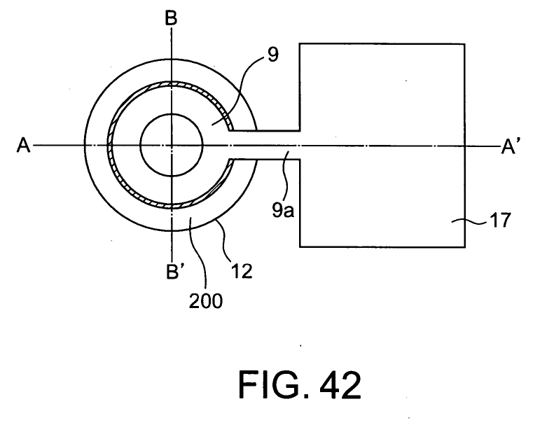

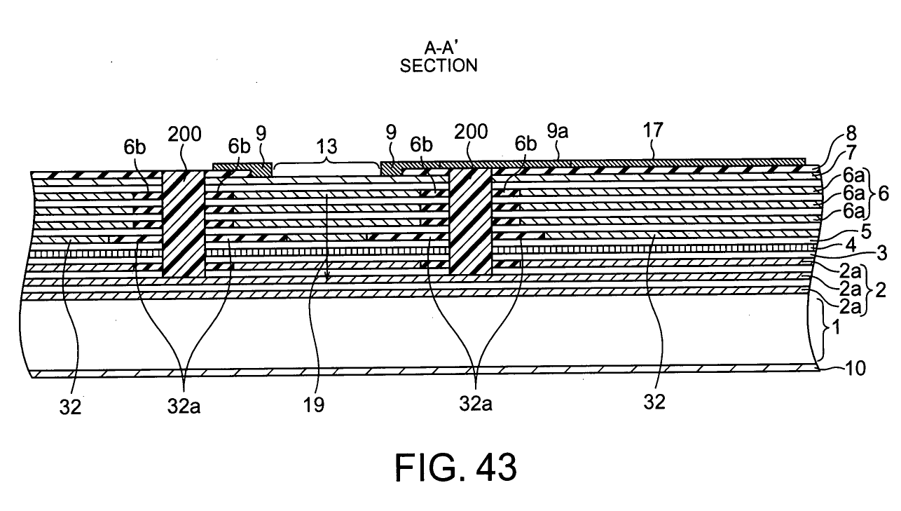

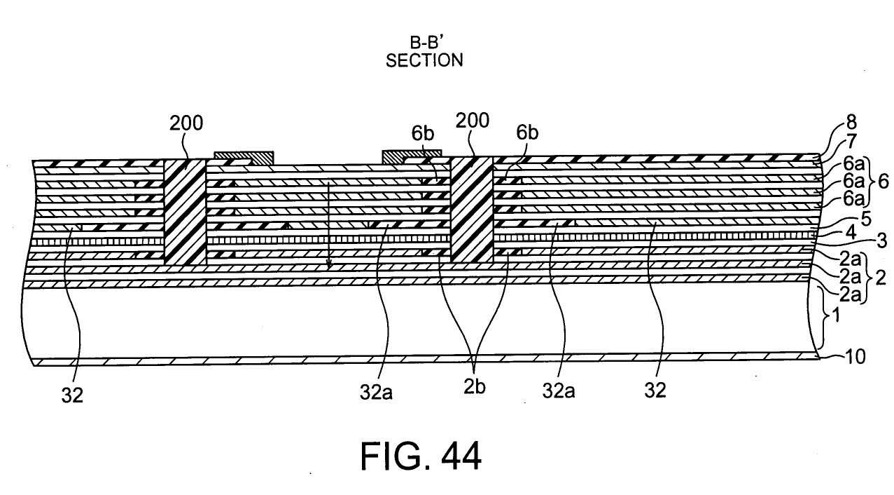

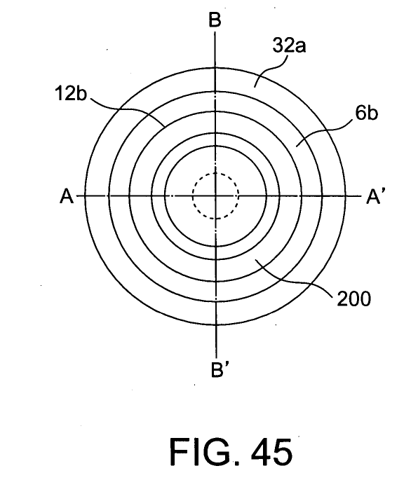

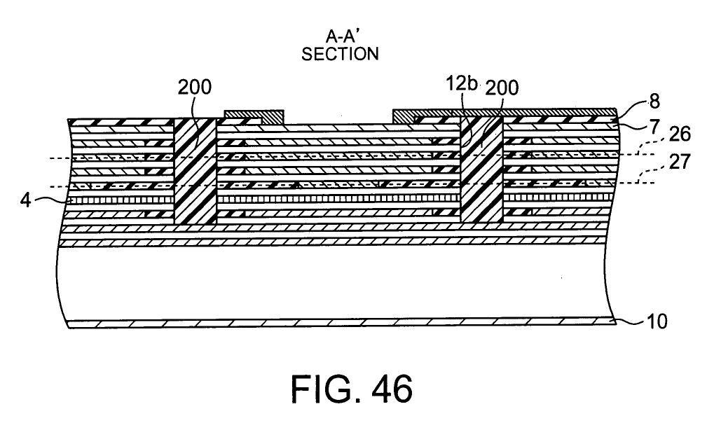

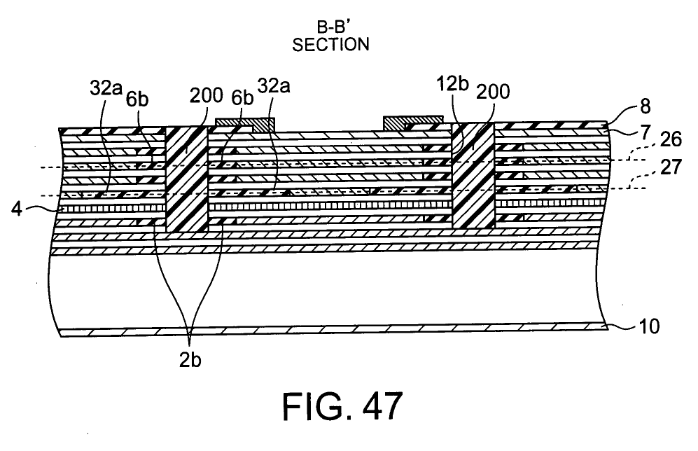

For comparison, a vertical cavity surface emitting laser diode of a comparative example having a structure shown in FIGS. 42 to 47 was manufactured. FIG. 42 is a plan view of the comparative example, FIG. 43 is a sectional view of the comparative example taken along line A-A′ shown in FIG. 42, FIG. 44 is a sectional view of the example taken along line B-B′ shown in FIG. 42, FIG. 45 is a view showing a shape of an oxidized region 32a of an upper to-be-oxidized layer 32, which is obtained when the vertical cavity surface emitting laser diode of the comparative example has been cut at a height 26 (see FIG. 47), FIG. 46 is a sectional view of the vertical cavity surface emitting laser diode of the comparative example taken along line A-A′ shown in FIG. 45, and FIG. 47 is a sectional view of the vertical cavity surface emitting laser diode of the comparative example taken along line B-B′ shown in FIG. 45.

The vertical cavity surface emitting laser diode of the comparative example has a structure where the lower to-be-oxidized layer 30 is removed, section sizes (diameters and depths) of the etching regions (recesses) 12a and 12b are set to the same, and the shape of the oxidized region 32a of the upper to-be-oxidized layer 32 is made symmetrical regardless of directions, namely in a concentric fashion in the vertical cavity surface emitting laser diode according to the first embodiment, as shown in FIGS. 42 to 47.

Thus, the shape of the oxidized region 32a of the to-be-oxidized layer 32 is symmetrical in the comparative example. Therefore, compression stress generated due to volume shrinkage according to oxidation of the to-be-oxidized layer 32 is applied to a central portion of the active layer 4 which is positioned at the center of the mesa portion 100 symmetrically, so that polarization control can not be conducted.

### EXAMPLE

Next, the method for manufacturing a vertical cavity surface emitting laser diode according to the first embodiment will be specifically explained as examples.

First, an n-type semiconductor multi-layer film reflecting mirror 2, a to-be-oxidized layer 30 for forming a current confinement portion, a cladding layer 3, a semiconductor active layer 4, a cladding layer 5, a to-be-oxidized layer 32 for forming the current confinement portion, a p-type semiconductor multi-layer film reflecting mirror 6, and a contact layer 7 were sequentially grown on a cleaned n-type GaAs substrate 1 with plane orientation (100) plane having 3-inch square and a thickness of 400 μm using a MOCVD (metal organic chemical vapor deposition) apparatus.

Here, assuming that a structure where the semiconductor multi-layer film reflecting mirrors 2 and 6 were disposed above and below an optical cavity constituted of the semiconductor active layer 4, and the cladding layers 3 and 5 was a basic structure, design and manufacture were performed such that optimal performances could be obtained as a GaInAsN vertical cavity surface emitting laser diode for a 1.3 μm band.

The semiconductor multi-layer film reflecting mirror 2 was structured such that n-type GaAs layer (high refractive index layer) and n-type Al_{y}Ga_{1-y}As layer (0<y<1) (low refractive index layer) were alternately stacked such that each layer had a thickness of ¼ optical wavelength of wavelength 1.3 μm. In the example, an Al_{0.94}Ga_{0.06}As layer having Al composition of y=0.94 was used for the low refractive index layer. Si is used as n-type dopant for the semiconductor multi-layer film reflecting mirror 2. The dopant concentration was set to 2×10¹⁸/cm³. The lower cladding layer 3 was an n-type GaInP layer.

The semiconductor active layer 4 has a quantum well structure obtained by stacking GaₓIn₁₋ₓAs_{y}N_{1-y} (0≦x≦1, 0≦y<1) layer controlled such that a light emission peak value was 1.3 μm and GaAs layer serving as a barrier layer alternately. Here, a three layer structure where the GaAs layers were disposed above and below the GaₓIn₁₋ₓAs_{y}N_{1-y} (0≦x≦1, 0≦y<1) layer was adopted. In the GaₓIn₁₋ₓAs_{y}N_{1-y} (0≦x≦1, 0≦y<1) layer, In composition was in a range of 30% to 35%, nitrogen composition was 0.5% to 1/0%, and a thickness of the layer was 7 nm.

Composition was controlled such that a lattice constant of the GaₓIn₁₋ₓAs_{y}N_{1-y} (0≦x≦1, 0≦y<1) layer was larger than that of the n-type GaAs substrate, so that Ga_{0.66}In_{0.34}As_{0.99}N_{0.01} including a compression strain amount of about 2.5% was adopted. At that time, a differential gain coefficient increased so that a threshold current value was further reduced as compared with non-strain case.

The upper cladding layer 5 was made from p-type GaInP. The semiconductor multi-layer film reflecting mirror 6 was structured such that p-type GaAs layer (high refractive index layer) and p-type Al_{y}Ga_{1-y}As layer (0<y<1) (low refractive index layer) were alternately stacked such that each layer had a thickness of ¼ optical wavelength of wavelength 1.3 μm. In the example, an Al_{0.94}Ga_{0.06}As layer having Al composition of y=0.94 was used for the low refractive index layer like the n-type semiconductor multi-layer reflecting mirror 2. C (Carbon) is used as p-type dopant for the semiconductor multi-layer film reflecting mirror 6. The dopant concentration was set in a range of 2×10¹⁸/cm³ (near the quantum well layer 4) to 1×10¹⁹/cm³ (near the contact layer 7).

The upper to-be-oxidized layer 32 and the lower to-be-oxidized layer 30 were formed above the cladding layer 5 and below the cladding layer 3, respectively, and AlₓGa₁₋ₓAs (x≧0.98) with an Al composition ratio larger than that of AlGaAs constituting the upper and lower semiconductor multi-layer film reflecting mirrors 6 and 2 were used as material for these layers. The contact layer 7 was made from p-type GaAs. C (carbon) was used as the p-type dopant, and the dopant concentration was set to 2×10¹⁹/cm³.

Next, an Si₃N₄ film was formed as a protective film 8 which also served as an etching mask for pattern forming. A film having a tensile stress of 150 MPa was formed by adjusting pressures and flow rates of material gas, SiH₄, NH₃, N₂ to control film stress. A value of the tensile stress of the film was determined considering a thermal stress Δ_{T} generated between the etching mask 8 and the GaAs substrate during vapor oxidizing process. When a vapor oxidizing process temperature is set to 400° C., a compression stress of σ_{T}=−150 MPa is generated between an Si₃N₄ film (E_{F}=160 GPa, σ_{F}=2.7×10⁻⁷/K) and GaAs (αₛ=6.0×10⁻⁶/K) of the substrate. The film with the tensile stress is formed in order to relax the compression stress so that heat resistance is elevated.

Next, photolithography and etching steps were conducted to form a mesa portion 100. A mesa pattern was etched using mixed gas of boron trichloride and nitrogen in an ICP (inductively coupled plasma) plasma dry etching apparatus. At that time, as shown in FIGS. 1 to 3, the mesa structure where recesses with different opening areas were respectively different in etching depth was fabricated by changing a size of an opening in the etching region for mesa formation between the line A-A′ direction and the line B-B′ direction (12a and 12b) and using so-called “micro-loading effect” where an etching rate changed depending on a difference in area of the opening.

By adjusting gas pressure, antenna output, bias output, and substrate temperature, fabrication of the mesa portion 100 was conducted, where regarding a side wall of the mesa portion 100, only the upper layer to be oxidized 32 was exposed in the line A-A′ direction of the etching region 12a, while the upper and lower to-be-oxidized layers 32 and 30 were exposed in the line B-B′ direction of the etching region 12b. Here, the etching region for mesa portion formation had such a constitution that a ratio of an opening area, a ratio of an etching depth, and an etching volume of the line A-A′ direction to an opening area to the line B-B′ direction were set to 1:3, 1:2, and 1:6. When crystal growth of a quantum well layer made from GaₓIn₁₋ₓAs_{y}N_{1-y} having a large strain to a substrate is performed as the example, each layer has a large film stress. Accordingly, compression stress or tensile stress is applied to the semiconductor active layer 4 asymmetrically in a horizontal direction to the substrate face due to a difference in etching volume between the etching regions 12a and 12b formed at a formation time of the mesa portion 100, which contributes to further elevation of the polarization controllability. Here, in order to fabricate a vertical cavity surface emitting laser diode having the opening (current confinement portion) having a diameter of 5 μm, a vertical shape etching with a diameter of 45 μm was performed to the mesa portion 100.

Next, in the selective oxidizing step, by performing thermal treatment at a temperature of 400° C. in a vapor atmosphere, the upper to-be-oxidized layer 32 and the lower to-be-oxidized layer 30 were respectively oxidized selectively over their lengths of 20 μm laterally to form the oxidized regions 32a and 30a so that a light emitting region 13 with a diameter of about 5 μm was formed. At that time, the semiconductor multi-layer film reflecting mirrors 6, 2 are also selectively oxidized laterally from the side wall of the mesa portion 100 toward the light emitting region 13. And oxidized regions 6b, 2b of the semiconductor multi-layer film reflecting mirrors 6, 2 are smaller than the oxidized regions 32a and 30a of the upper and lower to-be-oxidized layers 32, 30 since Al composition ratio of the semiconductor multi-layer film reflecting mirrors 6, 2 is smaller than that of the upper and lower to-be-oxidized layers 32, 30. Therefore, in mesa portion 100, un-oxidized regions are larger than that of the upper and lower to-be-oxidized layers 32, 30.

The to-be-oxidized layers 32 and 30 are selectively oxidized laterally from the side wall of the mesa portion 100 toward the light emitting region 13, compression stress F1 of 1 GPa to 10 GPa per one to-be-oxidized layer is generated due to volume shrinkage according to change of the to-be-oxidized layers (AlAs layers) 32 and 30 to the Al₂O₃ layers to be applied to the active layer 4 at the center of the mesa portion. At that time, since only the upper layer 32 is present in the line A-A′ direction, compression stress is F1 in the line A-A′ direction, and since the upper to-be-oxidized layer 32 and the lower to-be-oxidized layer 30 are present in the line B-B′ direction, the compression stress is 2×F1 in the line B-B′ direction. That is, it is considered that, since the compression stress applied to the active layer 4 is different for each direction, a gain difference between linear polarized waves is generated in the active layer 4, so that the polarization controllability is enhanced.

Next, burying processing using filler film material was performed to the recesses 12a and 12b surrounding the mesa portion 100. Here, photosensitive polyimide resin was used as the filler film material. Photosensitive polyimide resin CRC-8300 (manufactured by Sumitomo Bakelite Co., Ltd.) commercially available was rotationally applied under the condition of a rotation speed of 2000 rpm for 30 seconds by a spin-coater apparatus. Thereafter, a baking process was performed using a hot plate to form a photosensitive film with a film thickness of 6 μm. Next, rendering a pattern (400 mJ/cm²) for burying of polyimide resin was conducted on the recesses 12a and 12b using a mask aligner exposing apparatus. After rendering, developing processing was conducted using aqueous solution of 2.38% TMAH (tetra-methyl ammonium hydroxide). Thereafter, a heat hardening processing was conducted at a temperature of 150° C. for 30 minutes and at a temperature of 320° C. for 30 minutes in a nitrogen atmosphere to form filler films 200. Then, an oxygen plasma processing (gas pressure of 0.7 Pa and flow rate of 100 scm) with an antenna output of 500 W was conducted for 5 minutes in order to planarize the buried portion and a surrounding portion thereof to elevate tight adhesiveness with metal (electrode material) to be deposited.

Subsequently, the etching mask film 8 on the p-type semiconductor multi-layer film reflecting mirror 6 was removed to form a p-type side electrode 9 on the p-type GaAs contact layer 7. At that time, wires 18 and 9a for connecting the bonding pad 17 and the p-type side electrode 9 were simultaneously formed and a sintering processing was performed. Thereafter, substrate polishing was performed to the electrode 9 and the wire 18 until film thicknesses thereof reached 100 μm. Finally, n-type side electrode 10 is formed on a back face of the substrate.

In the vertical cavity surface emitting laser diode thus manufactured, continuous oscillation at a wavelength of 1.3 μm was achieved at the room temperature at a low threshold current density (1 kA/cm²) owing to introduction of compression strain to the active layer 4 and various characteristics as a laser were excellent. Polarization control was made possible so that fluctuation and switching of polarized waves were not caused. As a result, noise reduction was obtained so that the vertical cavity surface emitting laser diode could be utilized as an optical disk head or a device for communication,

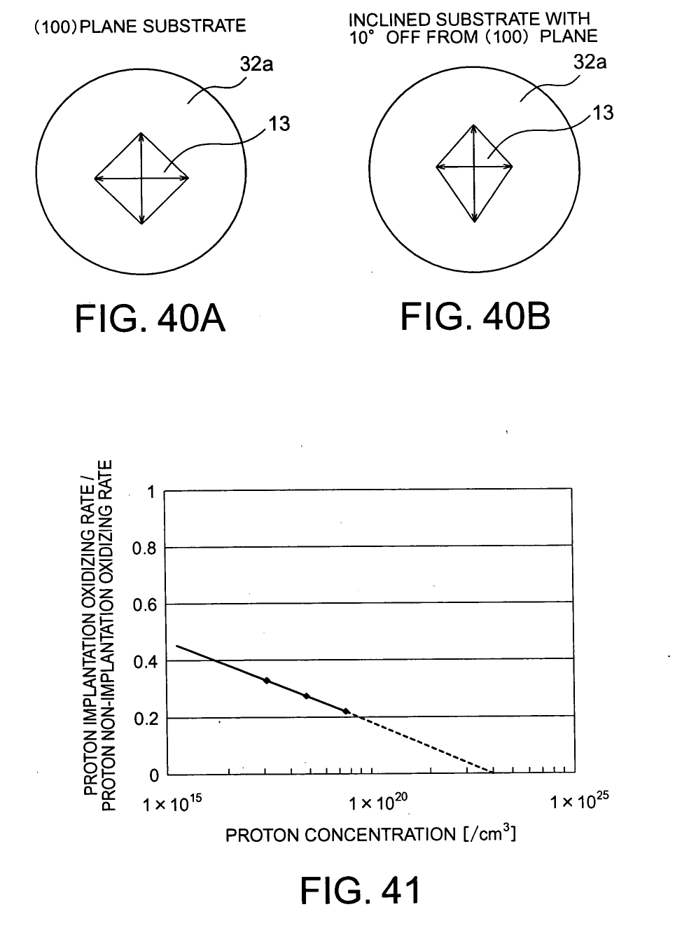

Strain of a non-oxidized region caused by anisotropic oxidation on the inclined substrate and a shape of an output beam pattern were improved so that a desired beam pattern shape could be obtained. As a result, stability in the transverse mode could be achieved. That is, for comparison, when manufacture was conducted using an inclined substrate 1 inclined at an arbitrary angle from (100) plane orientation substrate which was thought to be effective for enhancing polarization controllability, here, a substrate 10°-off inclined, distortion of a shape due to anisotropic oxidation was noticeable. In the same circular mesa structure as the example, a shape of an opening (light emitting region 13) took a shape distorted in the off direction, as shown in FIG. 40B, where a size difference between a longitudinal direction and a transverse direction was 1.1 μm. On the other hand, when a substrate with a plane orientation (100) plane was used, a symmetrical light emitting region 13 was obtained, as shown in FIG. 40A, where it was confirmed that a size difference between a longitudinal direction and a transverse direction was reduced to 0.1 μm. Reproducibility was excellent over a whole in-plane, sizes and shapes of many devices formed on the same or one wafer were made even, laser characteristics such as a single mode oscillation, a threshold, or light output were made even, and mass productivity of a vertical cavity surface emitting laser diode with high performance was improved.

(First Modification)

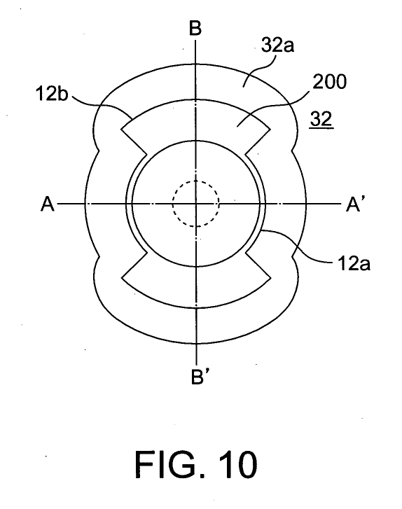

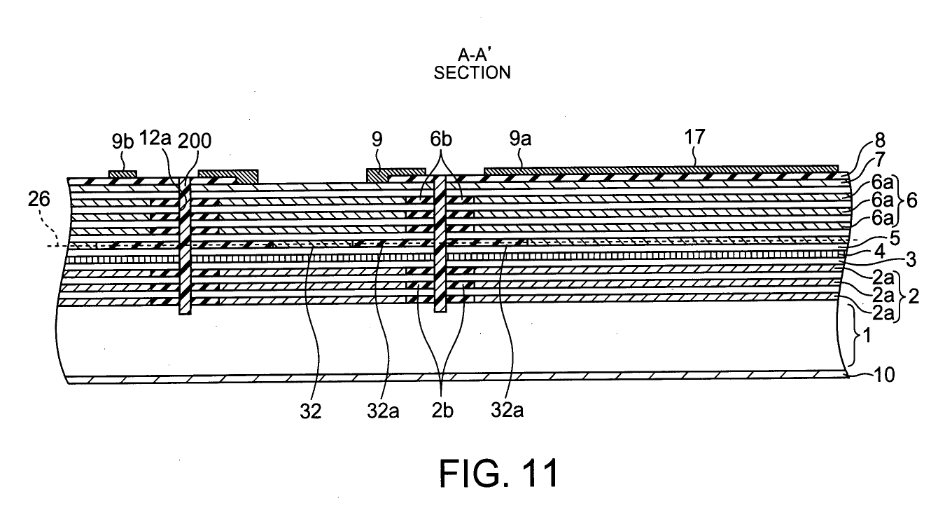

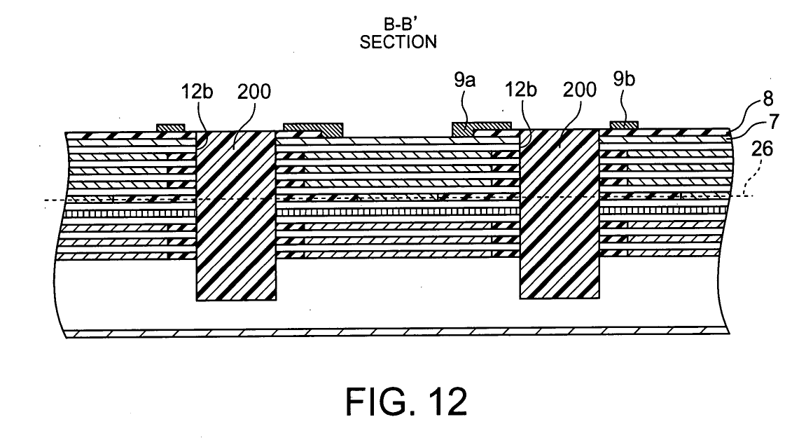

Next, a vertical cavity surface emitting laser diode according to a first modification of the first embodiment will be explained with reference to FIGS. 10 to 12. FIG. 10 is a view showing a shape of an oxidized region 32a of an upper to-be-oxidized layer 32 of a vertical cavity surface emitting laser diode according to a first modification of the first embodiment obtained when the vertical cavity surface emitting laser diode has been cut at a height 26 (see FIG. 11) thereof, FIG. 11 is a sectional view of the vertical cavity surface emitting laser diode according to the first modification, taken along line A-A′ shown in FIG. 10, and FIG. 12 is a sectional view of the vertical cavity surface emitting laser diode according to the first modification, taken along line B-B′ shown in FIG. 10.

The vertical cavity surface emitting laser diode according to the first modification has such a constitution that the lower to-be-oxidized layer 30 is removed, sizes (diameters and depths) of the etching regions (recesses) 12a and 12b are different and volumes of filler films 200 buried therein are different in the vertical cavity surface emitting laser diode according to the first embodiment.

The etching regions 12a and 12b in the line A-A′ direction and in the line B-B′ direction have a ratio of an opening area of 1:4, a ration of an etching depth of 2:3 and a ratio of an etching volume of 1:6. At that time, in the structure of the embodiment, only the upper to-be-oxidized layer 32a has symmetry both in the line A-A′ direction and in the line B-B′ direction, but the recess 12a in the line A-A′ direction and the recess 12b in the line B-B′ direction are significantly different in opening area and opening depth. Therefore, by using polyimide resin as material for the filler film 200, compression stress applied on the active layer 4 is greatly different among respective directions and among respective layers in a vertical direction, so that a gain difference between linear polarized waves occurs directly in the semiconductor active layer 4 and polarization controllability is enhanced. It is considered that, due to a difference in volume of the filler film 200 between the etching regions 12a and 12b in the line A-A′ direction and in the line B-B′ direction, compression stress is asymmetrically applied to the semiconductor active layer 4 in a horizontal direction to the substrate plane, which results in further contribution to enhancement of the polarization controllability.

According to the modification, a vertical cavity surface emitting laser diode which has high controllability to polarization mode and has high performance.

(Second Modification)

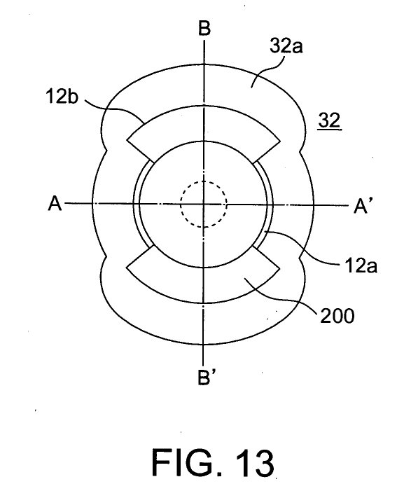

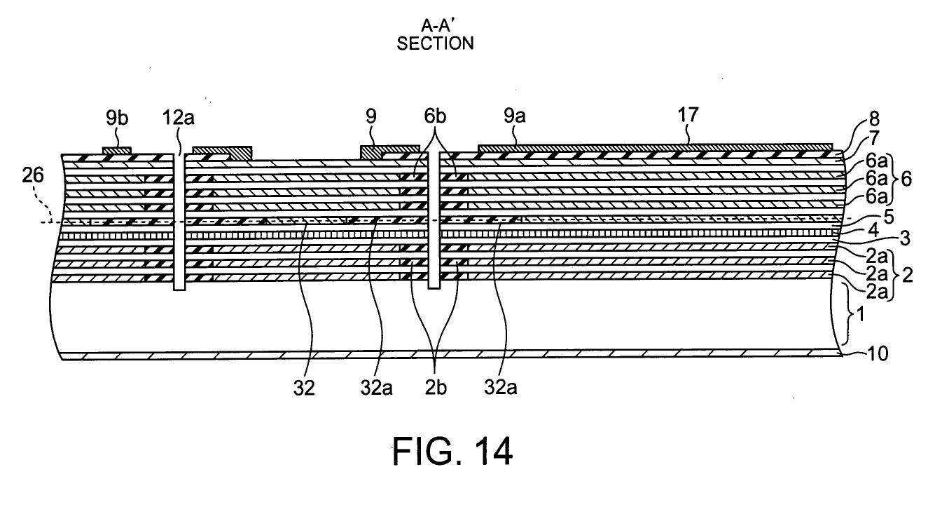

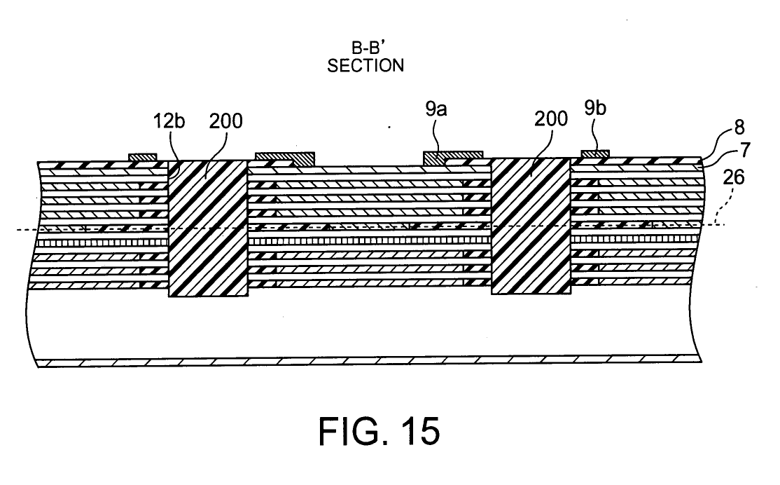

Next, a vertical cavity surface emitting laser diode according to a second modification of the first embodiment will be explained with reference to FIGS. 13 to 15. FIG. 13 is a view showing a shape of an oxidized region of an upper to-be-oxidized layer 32 of a vertical cavity surface emitting laser diode according to the modification obtained when the vertical cavity surface emitting laser diode has been cut at a height 26 thereof, FIG. 14 is a sectional view of the vertical cavity surface emitting laser diode, taken along line A-A′ shown in FIG. 13, and FIG. 15 is a sectional view of the vertical cavity surface emitting laser diode, taken along line B-B′ shown in FIG. 13.

The vertical cavity surface emitting laser diode according to the first modification has such a constitution that the lower to-be-oxidized layer 30 is removed, the depths of the etching regions (recesses) 12a and 12b are set at the same, and a filler film 200 is buried in the recess 12b but any filler film is not buried in the recess 12a in the vertical cavity surface emitting laser diode according to the first embodiment.

Since structure where a difference of stress applied to the active layer 4 is largely different between the line A-A′ direction and the line B-B′ direction due to presence or absence of the filler film 200 can be obtained like the modification, a gain difference between linear polarization waves occurs directly in the semiconductor active layer 4. Thereby, the polarization controllability is enhanced according to the modification.

Incidentally, it is apparent that the polarization controllability can be enhanced like the above by adopting a structure where the filler film 200 is not buried in the recess 12a for the vertical cavity surface emitting laser diode according to the first embodiment shown in FIGS. 1 to 9.

In the example of the first embodiment, explanation has been made using GaₓIn₁₋ₓAs_{y}N_{1-y} (0≦x≦1, 0≦y<1) as material for the active layer 4, but various materials such as InGaAlP base material, AlGaAs base material, or InGaAsP base material can be used instead of GaₓIn₁₋ₓAs_{y}N_{1-y} (0≦x≦1, 0≦y<1).

Various materials can be used as materials for the cladding layers 4 and 5, and the semiconductor multi-layer film reflecting mirrors 2 and 6. For example, a stacked structure of material with a large refractive index which does not include Al and material with a small refracting index may be used as the semiconductor multi-layer film reflecting mirrors 2 and 6 instead of the stacked structure of the AlGaAs layer and the GaAs layer. A combination of materials such as GaInP/GaAs, GaInPAs/GaAs, GaInP/GaInAs, GaInP/GaPAs, GaInP/GaInAs, or GaP/GaInAsN can be used.

As the growth process, an MBE (molecular beam epitaxy) process or the like can be used. In the example, an example of the triple quantum well structure has bee shown as the stacked structure, but a structure using another quantum well or the like can be used.

As the desired shape of the opening (light emitting region 13), the circular shape has been explained in the example, but the shape may be a square shape, a rectangular shape, or an oval shape. Similar function and advantage can be obtained even if these shapes are adopted, of course.

In the example, the AlAs layer was used as the to-be-oxidized layer 6a, 2a for forming the current confinement portion. However, it is apparent that similar function and advantage can be obtained even by using AlₓGa₁₋ₓAs (x≧0.95) with a high Al composition ratio. When the Al composition ratio is high, since an oxidizing rate is fast in a vapor oxidizing step so that a time required for conducting the step can be shortened. Since generation amounts of stress and strain according to oxidation are large, such a high Al composition ratio is suitable for elevating mass productivity and polarization controllability of a device.

The case that one upper to-be-oxidized layer 32 and one lower to-be-oxidized layer 30 are provided has been explained, but even when each of the to-be-oxidized layers 32 and 30 is constituted of a plurality of layers, similar function and advantage can be obtained. For example, when a constitution including one upper to-be-oxidized layer and two lower to-be-oxidized layers is adopted, asymmetry of compression stress applied to the semiconductor active layer 4 becomes further more significant than those of the example so that the polarization controllability can be further improved.

In the example, polyimide resin was used as material for the filler film 200. However, it is apparent that similar function and advantage can be obtained even when another polymer material or epoxy resin with a thermal expansion coefficient significantly different from that of semiconductor material such as materials for the substrate 1, the semiconductor multi-layer film reflecting mirrors, 6, 2, the to-be-oxidized layers 32, 20, and the semiconductor active layer 4 is used. For example, acrylic resin, epoxy resin, or polysilane can be used as material for the filler film 200 beside the polyimide resin.

### Second Embodiment

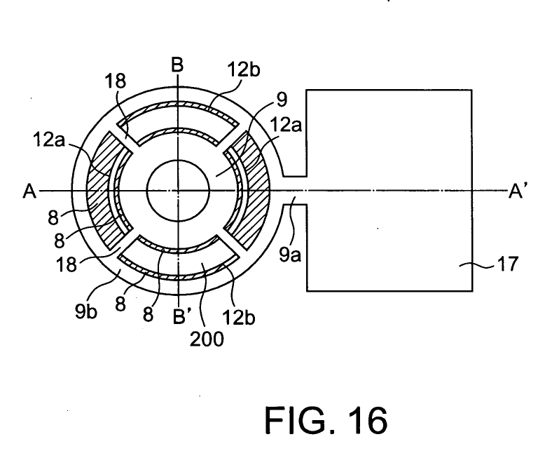

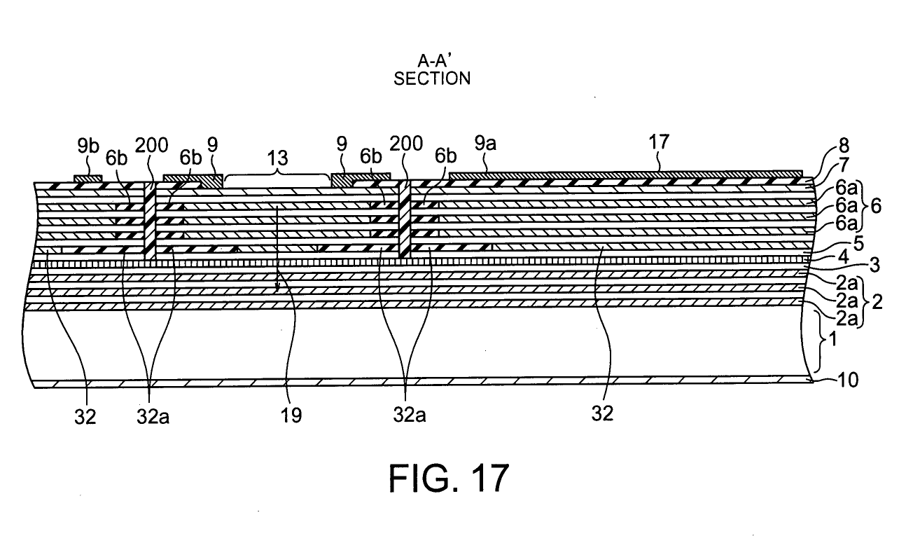

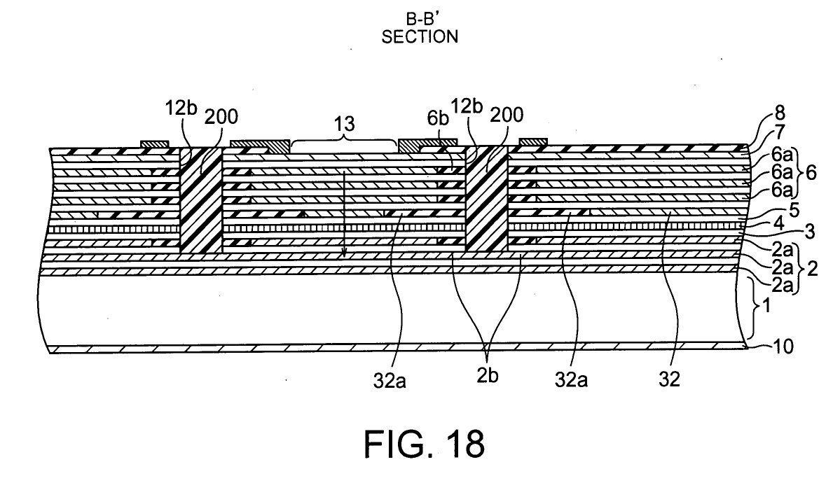

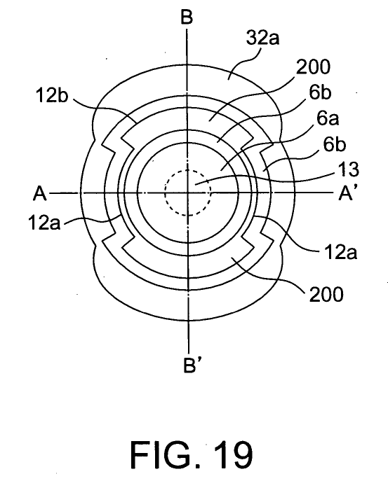

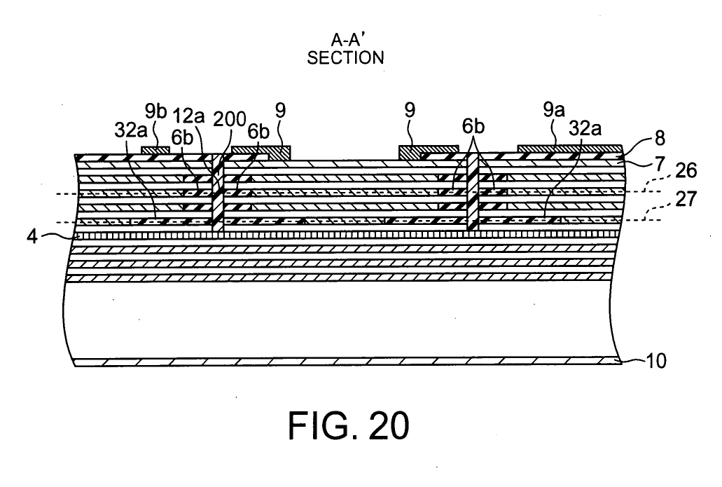

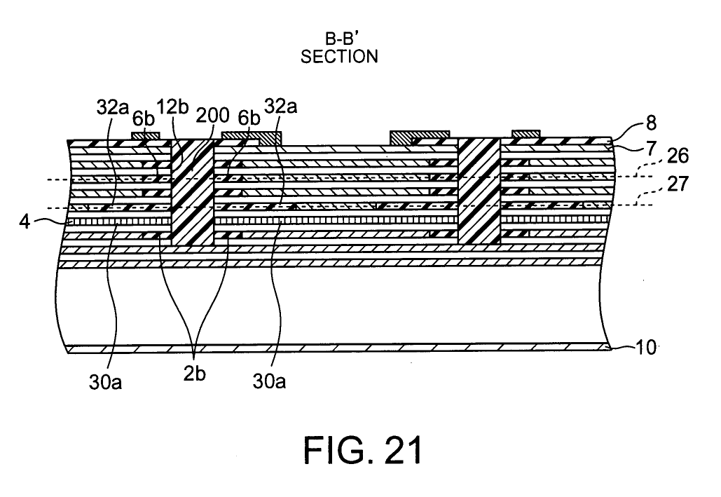

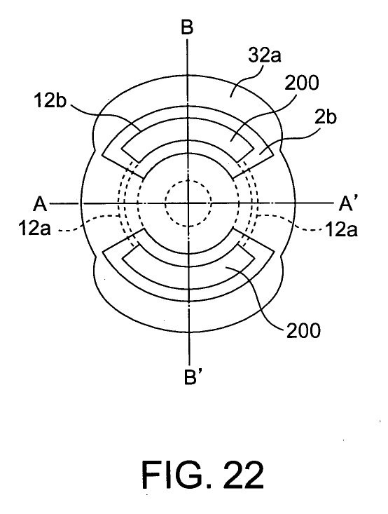

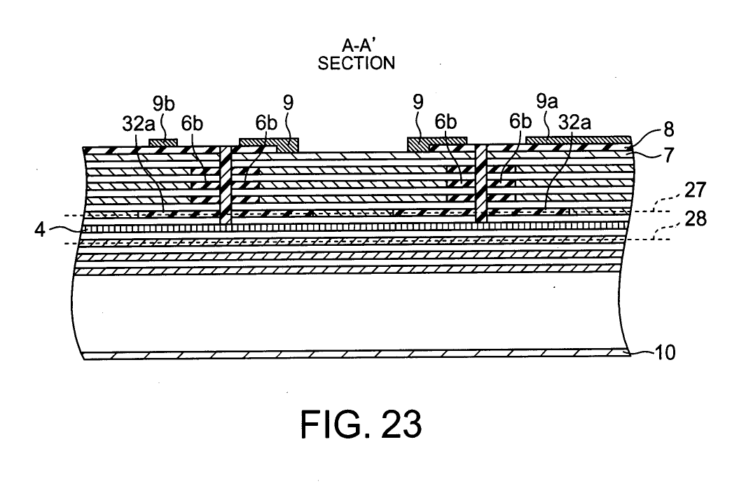

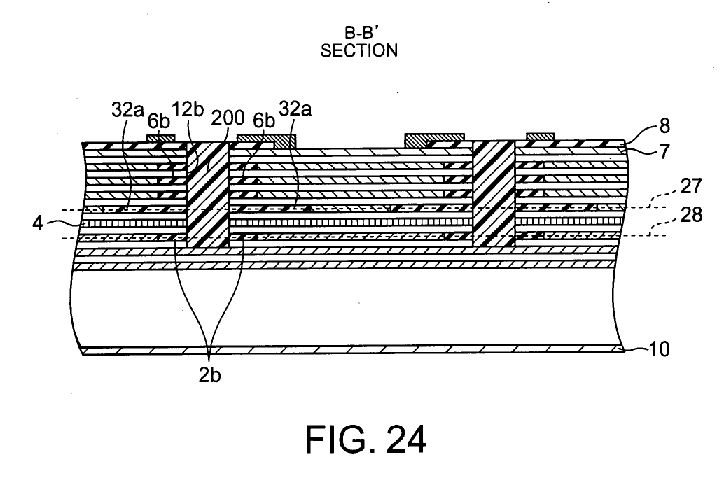

Next, a constitution of a vertical cavity surface emitting laser diode according to a second embodiment of the present invention will be explained with reference to FIGS. 16 and 24. FIG. 16 is a plan view of the vertical cavity surface emitting laser diode, FIG. 17 is a sectional view of the vertical cavity surface emitting laser diode taken along A-A′ shown in FIG. 16, and FIG. 18 is a sectional view of the vertical cavity surface emitting laser diode taken along B-B′ shown in FIG. 16. FIG. 19 is a view showing a shape of an oxidized region 6b of a semiconductor multi-layer reflecting mirror 6 of a vertical cavity surface emitting laser diode according to the second embodiment obtained when the vertical cavity surface emitting laser diode has been cut at a height 26 thereof and a shape of an oxidized region 32a of an upper to-be-oxidized layer 32 obtained when the vertical cavity surface emitting laser diode has been cut at another height 27 thereof in a superimposing manner, FIG. 20 is a sectional view of the vertical cavity surface emitting laser diode taken along line A-A′ shown in FIG. 19, and FIG. 21 is a sectional view of the vertical cavity surface emitting laser diode taken along line B-B′ shown in FIG. 19. FIG. 22 is a view showing a shape of an oxidized region 32a of a semiconductor multi-layer reflecting mirror 32 of a vertical cavity surface emitting laser diode according to the second embodiment obtained when the vertical cavity surface emitting laser diode has been cut at a height 27 thereof and a shape of an oxidized region 32a of an upper to-be-oxidized layer 32 when the vertical cavity surface emitting laser diode has been cut at another height 28 thereof in a superimposing manner, FIG. 23 is a sectional view of the vertical cavity surface emitting laser diode taken along line A-A′ shown in FIG. 22, and FIG. 24 is a sectional view of the vertical cavity surface emitting laser diode taken along line B-B′ shown in FIG. 22.

The vertical cavity surface emitting laser diode according to the embodiment has a structure that the lower to-be-oxidized layer 30 is removed, shapes of the oxidized regions 6b and 2b in the semiconductor multi-layer film are asymmetric, as shown in FIGS. 19 and 22, and the numbers of the Al high concentration layers 2a and 6a in the semiconductor multi-layer films to be oxidized are different for respective portions of the side wall of the mesa portion 100 in the vertical cavity surface emitting laser diode according to the first embodiment shown in FIGS. 1 to 9. When a difference between the numbers of the Al high concentration layers 2a and 6a of the semiconductor multi-layer films to be oxidized is ten, a stress difference in the order of several tens GPa is generated in an anisotropic manner as a whole. Therefore, stress and strain applied to the semiconductor active layer 4 largely change depending on respective directions and they acts on the active layer positioned at the center of the mesa portion at a proximity position thereof, so that the polarization controllability is enhanced. In addition, by using polyimide resin as material for the filler film buried in the recess around the mesa portion, stress (strain) is increased and asymmetry can be elevated, so that the polarization controllability can be further enhanced. Thereby, a vertical cavity surface emitting laser diode with high polarization controllability can be obtained.

Next, a method for manufacturing the vertical cavity surface emitting laser diode according to the embodiment will be explained specifically.

First, a n-type semiconductor multi-layer film reflecting mirror 2, a to-be-oxidized layer 2a for forming a current confinement portion 14, a semiconductor cladding layer 3, a semiconductor active layer 4, a semiconductor cladding layer 5, a to-be-oxidized layer 6a for forming the current confinement portion 14, a p-type semiconductor multi-layer film reflecting mirror 6, and a contact layer 7 were sequentially grown on a cleaned n-type GaAs substrate 1 with plane orientation (100) plane having 3-inch square and a thickness of 400 μm using a MOCVD apparatus.

Here, assuming that a structure where semiconductor multi-layer film reflecting mirrors 2 and 6 were disposed above and below an optical cavity constituted of the semiconductor active layer 4, and the cladding layers 3 and 5 was a basic structure, design and manufacture were performed as a GaInAsN vertical cavity surface emitting laser diode for a 1.3 μm band.

The semiconductor multi-layer film reflecting mirror 2 was structured such that n-type GaAs layer (high refractive index layer) and n-type Al_{y}Ga_{1-y}As layer (0<y<1) (low refractive index layer) were alternately stacked such that each layer had a thickness of ¼ optical wavelength of wavelength 1.3 μm. In the exmbodiment, an Al_{0.94}Ga_{0.06}As layer having Al composition of y=0.94 was used for the low refractive index layer. Si is used as n-type dopant for the semiconductor multi-layer film reflecting mirror 2. The dopant concentration was set to 2×10¹⁸/cm³.

The semiconductor cladding layer 3 was made from n-type GaInP. The semiconductor active layer 4 has a quantum well structure obtained by stacking GaₓIn₁₋ₓAs_{y}N_{1-y} (0≦x≦1, 0≦y<1) layer adjusted such that a light emission peak value was 1.3 μm and a GaAs layer serving as a barrier layer alternately. Here, a three layer structure where the GaₓIn₁₋ₓAs_{y}N_{1-y} (0≦x≦1, 0≦y<1) layer was disposed at the center and the GaAs layers were disposed above and below the same was adopted. In the GaₓIn₁₋ₓAs_{y}N_{1-y} (0≦x≦1, 0≦y<1) layer, In composition was in a range of 30% to 35%, nitrogen composition was 0.5% to 1.0%, and a thickness of the layer was 7 nm. Composition was controlled such that a lattice constant of the GaₓIn₁₋ₓAs_{y}N_{1-y} (0≦x≦1, 0≦y<1) layer was larger than that of the n-type GaAs substrate, so that Ga_{0.66}Om_{0.34}As_{0.99}N_{0.01} including a compression strain amount of about 2.5% was adopted. At that time, a differential gain coefficient increased so that a threshold current value was further reduced as compared with non-strain case.

The semiconductor cladding layer 5 was made from p-type GaInP. The semiconductor multi-layer film reflecting mirror 6 was structured such that p-type GaAs layer (high refractive index layer) and p-type Al_{y}Ga_{1-y}As layer (0<y<1) (low refractive index layer) were alternately stacked such that each layer had a thickness of ¼ optical wavelength of wavelength 1.3 μm. In the embodiment, an Al_{0.94}Ga_{0.06}As layer having Al composition of y=0.94 was used for the low refractive index layer like the n-type semiconductor multi-layer reflecting mirror 2. C (carbon) is used as p-type dopant for the semiconductor multi-layer film reflecting mirror 6. The dopant concentration was set in a range of 2×10¹⁸/cm³ (near the quantum well layer 4) to 1×10¹⁹/cm³ (near the contact layer 7).

The to-be-oxidized layer 32 was formed on the cladding layer 5, and AlₓGa₁₋ₓAs (x≧0.98) with an Al composition ratio larger than that of AlGaAs constituting the upper layer and lower layer semiconductor multi-layer film reflecting mirrors 6 and 2 was used as material for the to-be-oxidized layer 32. In the embodiment, Al_{0.98}Ga_{0.02}As layer was used as the material for the to-be-oxidized layer 32. The contact layer 7 was made from p-type GaAs. C (carbon) was used as the p-type dopant, and the dopant concentration was set to 2×10¹⁹/cm³.

Next, an Si₃N₄ film was formed as a protective film 8 which also served as an etching mask for pattern forming like the example of the first embodiment.

Next, etching was conducted down to the n-type semiconductor multi-layer film reflecting mirror to form a mesa portion 100 according to photolithography step. A mesa pattern was etched using mixed gas of boron trichloride and nitrogen in an ICP (inductively coupled plasma) plasma dry etching apparatus. At that time, a condition where anisotropic etching occurs was satisfied by adjusting an antenna output, a bias output, and a substrate temperature. Here, cylindrical etching with a diameter of 45 μm was performed on the mesa in order to manufacture a vertical cavity surface emitting laser diode having a circular opening (current confinement portion) 14 with a diameter of 5 μm.

Next, heat treatment was conducted in a vapor atmosphere to selectively oxidize the to-be-oxidized layer 32 laterally, thereby forming an oxidized region 32a. Formation of the oxidized region 32a according the vapor selective oxidation was conducted at a temperature of 420° C. in the heat treatment. A oxidizing rate of the Al_{0.94}Ga_{0.06}As layer used as the Al high concentration layer 6a, 2a in the semiconductor multi-layer film reflecting layer 6, 2 was about ¼ the Al_{0.98}Ga_{0.02}AS layer of the to-be-oxidized layer 32 at the substrate temperature of 420° C., where since an oxidation length of the to-be-oxidized layer 32 was set to 20 μm in order to form the oxidized region 32a, oxidation lengths of the Al high concentration layers 6a and 2a of the semiconductor multi-layer film reflecting mirrors 6 and 2 in a lateral direction became 5 μm. At that time, asymmetry occurs in compression stress applied to the active layer positioned at the center of the mesa portion 100 due to different etching depths for mesa portion formation. Volume shrinkage due to oxidation of the Al_{0.94}Ga_{0.06}As layer which is the Al high concentration layer 6a in the semiconductor multi-layer film reflecting mirror 6 is in a range of 7.8% to 8.5%. Therefore, when a difference in the number of the Al high concentration layers of the semiconductor multi-layer film reflecting mirror to be oxidized between the side walls of the recesses 12a and 12b having different etching depths is ten, stress in the order to several tens GPa occurs as a whole, and magnitudes of stress and strain applied to the active layer change according to respective directions. Though stress occurring in one layer is smaller than that in the to-be-oxidized layer 32 including Al at further high concentration, and the Al high concentration layers are positioned at a distance far from the active layer at the center of the mesa portion, total stress becomes large according to increase in difference in the number of the Al high concentration layers to be oxidized, so that equivalent polarization controllability and shape controllability can be obtained. In the inclined substrate, it was shown that distortion of a shape occurring in an off-angle direction (a size difference of 0.75 μm between a longitudinal direction and a transverse direction) was reduced to 0.1 μm.

Next, a filler film 200 for burying in the recesses 12a and 12b surrounding the mesa portion 100 was formed using photosensitive polyimide resin. Next, a bonding pad 17 was formed. Then, the protective film 8, serving as a light taking-out port, on the p-type semiconductor multi-layer film reflecting mirror 6 was removed, and a p-side electrode 9 was formed on the p-type GaAs contact layer 7. At that time, wires 18 and 9a for connecting the bonding pad 17 and the p-side electrode 9 were simultaneously formed, and thereafter an n-side electrode 10 was formed on a back face of the substrate.

In the vertical cavity surface emitting laser diode thus manufactured, continuous oscillation at a wavelength of 1.3 μm was achieved at the room temperature at a low threshold current density owing to introduction of compression strain to the active layer 4 and various characteristics at a high temperature were excellent. Polarization control was made possible so that fluctuation and switching of polarized waves were not caused. As a result, noise reduction was obtained so that the vertical cavity surface emitting laser diode could be utilized as an optical disk head or a device for communication,

A non-oxidized region occurring due to anisotropic oxidation and a size and a shape of outgoing beam pattern could be improved so that desired size and shape of beam pattern could be obtained like the first embodiment.

In the embodiment, explanation has been made using GaₓIn₁₋ₓAs_{y}N_{1-y} (0≦x≦1, 0≦y<1) as material for the active layer 4, but various materials such as InGaAlP base material, AlGaAs base material, or InGaAsP base material can be used instead of GaₓIn₁₋ₓAs_{y}N_{1-y} (0≦x≦1, 0≦y<1). Various materials can be used as materials for the cladding layers 4 and 5, and the semiconductor multi-layer film reflecting mirrors 2 and 6. For example, a stacked structure of material with a large refractive index which does not include Al and material with a small refracting index may be used as the semiconductor multi-layer film reflecting mirrors 2 and 6 instead of the stacked structure of the AlGaAs layer and the GaAs layer. A combination of materials such as GaInP/GaAs, GaInPAs/GaAs, GaInP/GaInAs, GaInP/GaPAs, GaInP/GaInAs, or GaP/GaInAsN can be used.

As the growth process, an MBE process or the like can be used. In the example, an example of the triple quantum well structure has been shown as the stacked structure, but a structure using another quantum well or the like can be used.

The case that only one layer has been provided as each of the upper and lower to-be-oxidized layers has been explained, but each of the upper and lower to-be-oxidized layers 32 may be constituted of plural layers.

In the embodiment, a circular shape was used as the shape of a desired opening (light emitting region 13), but similar function and advantage can be obtained when a square shape, a rectangular shape, or an oval shape is used, too.

In the embodiment, the Al_{0.98}Ga_{0.02}As layer was used as the to-be-oxidized layer 32 for forming the current confinement portion. However, it is apparent that similar function and advantage can be obtained when an AlAs layer or AlₓGa₁₋ₓAs (x≧0.95) with low Al composition ratio is used too.

### Third Embodiment

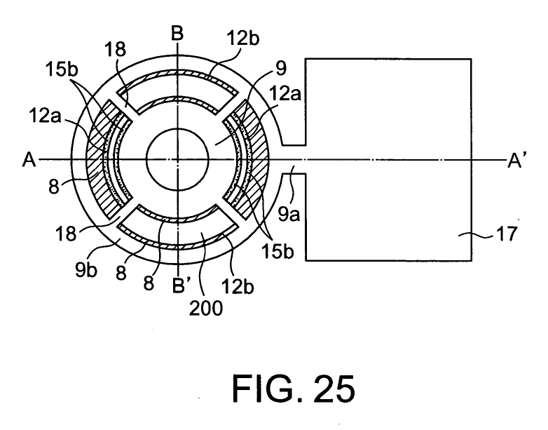

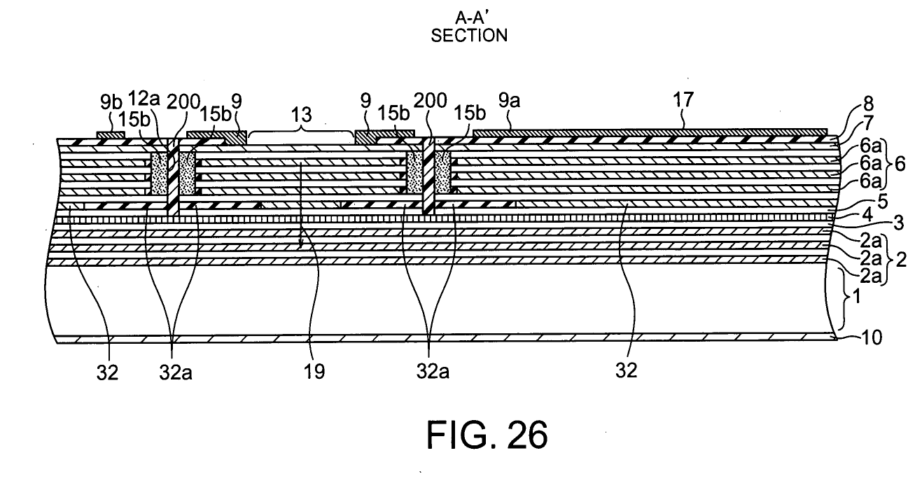

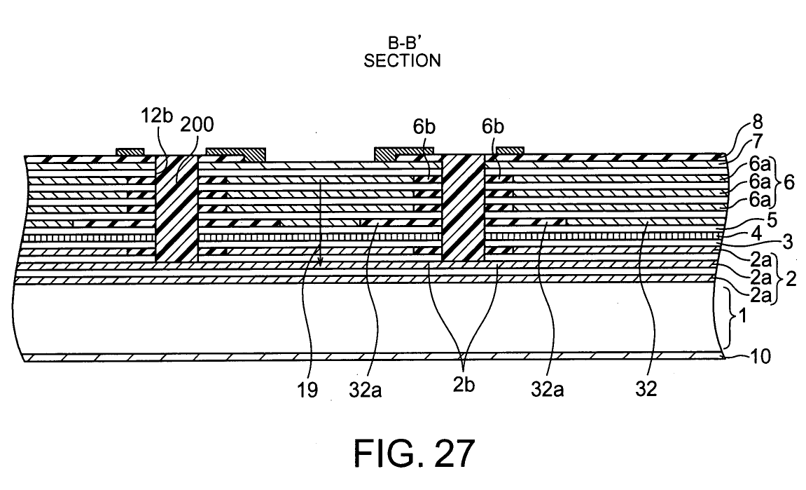

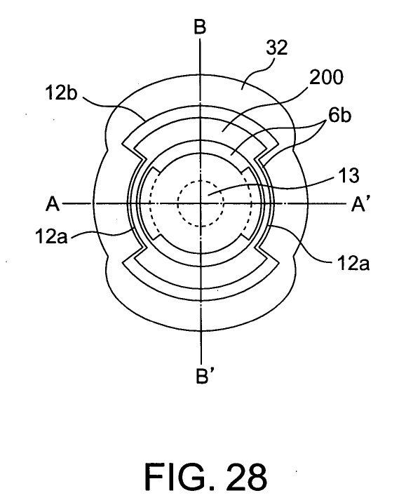

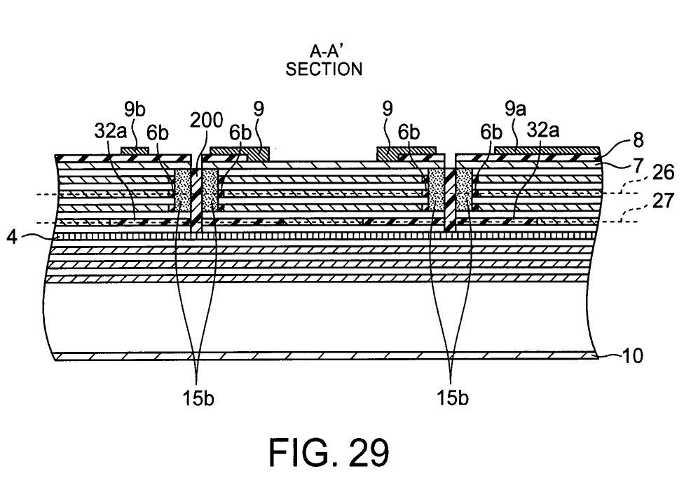

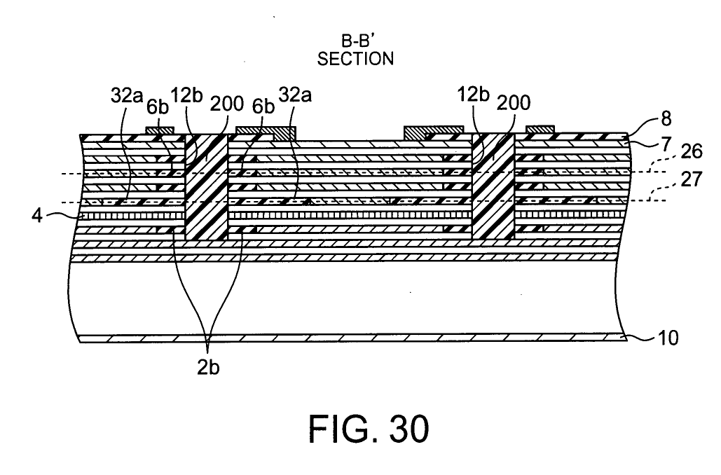

Next, a constitution of a vertical cavity surface emitting laser diode according to a third embodiment of the present invention will be explained with reference to FIGS. 25 and 30. FIG. 25 is a plan view of the vertical cavity surface emitting laser diode, FIG. 26 is a sectional view of the vertical cavity surface emitting laser diode taken along A-A′ shown in FIG. 25, and FIG. 27 is a sectional view of the vertical cavity surface emitting laser diode taken along B-B′ shown in FIG. 25. FIG. 28 is a view showing a shape of an oxidized region 6b of a semiconductor multi-layer reflecting mirror 6 of a vertical cavity surface emitting laser diode according to the third embodiment obtained when the vertical cavity surface emitting laser diode has been cut at a height 26 thereof and a shape of an oxidized region 32a of an upper to-be-oxidized layer 32 obtained when the vertical cavity surface emitting laser diode has been cut at another height 27 thereof in a superimposing manner, FIG. 29 is a sectional view of the vertical cavity surface emitting laser diode taken along line A-A′ shown in FIG. 28, and FIG. 30 is a sectional view of the vertical cavity surface emitting laser diode taken along line B-B′ shown in FIG. 28.

The vertical cavity surface emitting laser diode according to the embodiment has a structure that the lower to-be-oxidized layer 30 is removed and a proton implantation region 15 for controlling an oxidizing rate is provided in a first semiconductor multi-layer film reflecting mirror 6 in the vertical cavity surface emitting laser diode according to the first embodiment shown in FIGS. 1 to 9.

In the Al high concentration layer 6a constituting a first semiconductor multi-layer film reflecting mirror 6 provided with the proton implantation region 15, the oxidation rate is largely reduced (decelerated) in proportion to a proton concentration in vapor oxidation, as shown in FIG. 41. Therefore, oxidizing lengths from side faces of the recesses 12a and 12b are short in the proton implantation region 15, where stress becomes smaller than that in the Al high concentration layer 6a of the semiconductor multi-layer film reflecting mirror with a long oxidation length (proton is not implanted), so that application of strain applied to the semiconductor active layer 4 at the center of the mesa portion becomes aisotropic (asymmetric). Accordingly, in the vertical cavity surface emitting laser diode according to the embodiment, polarization controllability can be improved and a high performance can be achieved like the first and second embodiments. The vertical cavity surface emitting laser diode according to the embodiment can be manufactured easily, so that mass productivity thereof can also be improved.

Next, a method for manufacturing the vertical cavity surface emitting laser diode according to the embodiment will be explained specifically.

First, a n-type semiconductor multi-layer film reflecting mirror 2, a semiconductor cladding layer 3, a semiconductor active layer 4, a semiconductor cladding layer 5, a to-be-oxidized layer 32 forming a current confinement portion, a p-type semiconductor multi-layer film reflecting mirror 6, and a contact layer 7 were sequentially grown on a cleaned n-type GaAs substrate 1 with plane orientation (100) plane having 3-inch square and a thickness of 400 μm using an MOCVD apparatus.

Here, assuming that a structure where semiconductor multi-layer film reflecting mirrors 2 and 6 were disposed above and below an optical cavity constituted of the semiconductor active layer 4, and the cladding layers 3 and 5 was a basic structure, design and manufacture were performed as a GaInAsN vertical cavity surface emitting laser diode for a 1.3 μm band.

The semiconductor multi-layer film reflecting mirror 2 was structured such that n-type GaAs layer (high refractive index layer) and n-type Al_{y}Ga_{1-y}As layer (0<y<1) (low refractive index layer) were alternately stacked such that each layer had a thickness of ¼ optical wavelength of wavelength 1.3 μm. In the embodiment, an Al_{0.94}Ga_{0.06}As layer having Al composition of y=0.94 was used for the low refractive index layer. Si is used as n-type dopant for the semiconductor multi-layer film reflecting mirror 2. The dopant concentration was set to 2×10¹⁸/cm³.

As material for the semiconductor cladding layer 3, n-type GaInP was used. The semiconductor active layer 4 had a quantum well structure obtained by stacking GaₓIn₁₋ₓAs_{y}N_{1-y (}0≦x≦1, 0≦y<1) layer adjusted such that a light emission peak value was 1.3 μm and a GaAs layer serving as a barrier layer alternately. Here, a three layer structure where the GaₓIn₁₋ₓAs_{y}N_{1-y} (0≦x≦1, 0≦y<1) layer was disposed at the center and the GaAs layers were disposed above and below the same was adopted. In the GaₓIn₁₋ₓAs_{y}N_{1-y} (0≦x≦1, 0≦y<1) layer, in composition was in a range of 30% to 35%, nitrogen composition was 0.5% to 1.0%, and a thickness of the layer was 7 nm. Composition was controlled such that a lattice constant of the GaₓIn₁₋ₓAs_{y}N_{1-y} (0≦x≦1, 0≦y<1) layer was larger than that of the n-type GaAs substrate, so that composition Ga_{0.66}In_{0.34}As_{0.99}N_{0.01} including a compression strain amount of about 2.5% was adopted. At that time, a differential gain coefficient increased so that a threshold current value was further reduced as compared with non-strain case.

The semiconductor cladding layer 5 was made from p-type GaInP. The semiconductor multi-layer film reflecting mirror 6 was structured such that p-type GaAs layer (high refractive index layer) and p-type Al_{y}Ga_{1-y}As layer (0<y<1) (low refractive index layer) were alternately stacked such that each layer had a thickness of ¼ optical wavelength of wavelength 1.3 μm. In the embodiment, an Al_{0.94}Ga_{0.06}As layer having Al composition of y=0.94 was used for the low refractive index layer like the n-type semiconductor multi-layer reflecting mirror 2. C is used as p-type dopant for the semiconductor multi-layer film reflecting mirror 6. The dopant concentration was set in a range of 2×10¹⁸/cm³ (near the quantum well layer 4) to 1×10¹⁹/cm³ (near the contact layer 7).

The upper to-be-oxidized layers 32 were formed above the cladding layer 5 and below the cladding layer 3, respectively, and AlₓGa₁₋ₓAs (x≧0.98) whose Al composition ratio was larger than that of the AlGaAs constituting the upper and lower semiconductor multi-layer film reflecting mirrors 6 and 2 were used as material for the upper to-be-oxidized layers 32. In the embodiment, AlₓGa₁₋ₓAs (x=0.98) was used as the material for the upper to-be-oxidized layers 32. The contact layer 7 was made from p-type GaAs. C (carbon) was used as the p-type dopant, and the dopant concentration was set to 2×10¹⁹/cm³.

Next, an Si₃N₄ film was formed as a protective film 8 which also served as an etching mask for mesa pattern forming using photolithography step. Subsequently, the proton implantation region 15 was formed using the protective film 8 and a resist pattern (not shown) used for patterning the protective film 8 as a mask. Ion implantation was conducted in the Al high concentration layer 6a of the semiconductor multi-layer film reflecting mirror 6 under such conditions that a acceleration voltage was 200 kev and a dose amount was 3×10¹³/cm² by an ion implanting apparatus. The proton region 15 formed at that time was a region where the maximum concentration of a portion from the surface to a depth of 1.51 μm was 1×10¹⁸/cm³ and a concentration of a portion from the surface to 1 μm to 2 μm was 1×10¹⁶/cm³ or more. Proton was not implanted into the Al_{0.98}Ga_{0.02}As layer (a portion from the surface to a depth of 2.6 μm) of the to-be-oxidized layer 32. In this condition, the proton implantation region had a proton concentration which does not change the region to a high resistance region. As understood from a proton concentration dependency of the oxidizing rate of the AlGaAs layer shown in FIG. 41, the oxidizing rate lowers to about ⅓ thereof at a proton concentration of 1×10¹⁷/cm³. Accordingly, in the Al high concentration layer 6a of the semiconductor multi-layer film reflecting mirror 6 which has been implanted with proton, the oxidizing rate large lowers in the vapor oxidizing step, so that the oxidation length can be reduced to about ⅓ and device resistance does not become so high.

Next, a pattern for mesa formation was formed on the protective film 8 using resist, and etching was conducted down to the upper portion of the n-type semiconductor multi-layer film reflecting mirror 2 using the pattern for mesa formation as a mask in photolithography step, so that a mesa portion 100 was formed. A mesa pattern was etched using mixed gas of boron trichloride and nitrogen in an ICP (inductively coupled plasma) plasma dry etching apparatus. At that time, a condition where anisotropic etching occurs was satisfied by adjusting an antenna output, a bias output, and a substrate temperature. Here, cylindrical etching with a diameter of 45 μm was performed on the mesa in order to manufacture a vertical cavity surface emitting laser diode having a circular opening (light emitting region 13) with a diameter of 5 μm.

Next, heat treatment of 420° C. was conducted in a vapor atmosphere to selectively oxidize the to-be-oxidized layer 32 laterally, thereby forming an oxidized region 32a serving as the current confinement portion. An oxidizing rate of the Al_{0.94}Ga_{0.06}As layer which was the Al high concentration layer 6a in the semiconductor multi-layer film reflecting layer 6 was about ¼ of the Al_{0.98}Ga_{0.02}As layer which was the to-be-oxidized layer 32 at the substrate temperature of 420° C. Here, since an oxidation length of the to-be-oxidized layer 32 was set to 20 μm in order to form the oxidized region 32a, oxidation lengths of the Al high concentration layers 6a in the semiconductor multi-layer film reflecting mirrors 6 (which was not implanted with proton) in a lateral direction became 5 μm. The oxidation length in the proton implantation region 15 was reduced to about ⅓ of the former oxidation length, i.e., 1.7 μm, so that asymmetry of compression stress applied to the active layer 3 at the center of the mesa portion 100 was caused. Volume shrinkage of the Al_{0.94}Ga_{0.06}As layer which was the Al high concentration layer 6a in the semiconductor multi-layer film reflecting mirror 6 due to oxidation was in a range of 7.5% to 8.5%, and when the number of the semiconductor multi-layer film reflecting mirrors to be implanted with proton was set to 10, stress in the order of several tens GPa is generated as a whole. Further, magnitude of stress or strain applied to the active layer 4 decreases in inverse proportion to a distance between the center of the active layer 4 and the to-be-oxidized layer 32, so that compression stress applied to the active layer 4 largely changes for respective directions. When a vertical cavity surface emitting laser diode where the oxidation length from a side wall was 20 μm and a non-oxidation (light emitting) region 13 had a diameter of 5 μm was manufactured, it was shown that distortion (size difference between a longitudinal direction and a transverse direction was 0.75 μm) of a shape generated in an off-angle direction in an inclination substrate (10° off) was reduced to 0.1 μm in an ordinary substrate (100).

Next, a filler film material (for example, polyimide resin) was buried in the recesses 12a and 12b surrounding the mesa portion 100 using photosensitive polyimide resin) to form a filler film 200. Next, a bonding pad 17 was formed. Then, the protective film 8, serving as a light taking-out port, on the p-type semiconductor multi-layer film reflecting mirror 6 was removed, and a p-side electrode 9 was formed on the p-type GaAs contact layer 7. At that time, wires 18 and 9a for connecting the bonding pad 17 and the p-side electrode 9 were simultaneously formed, and thereafter an n-side electrode 10 was formed on a back face of the substrate.

In the vertical cavity surface emitting laser diode thus manufactured, leakage current was prevented and continuous oscillation at the room temperature in a single mode could be obtained at a low threshold current density due to not only introduction of compression strain to the active layer 4 but also high resistance obtained by proton implantation below the wiring bus, and characteristics at a high temperature was excellent. Polarization control was made possible so that fluctuation and switching of polarized waves were not caused. As a result, noise reduction was obtained so that the vertical cavity surface emitting laser diode could be utilized as an optical disk head or a device for communication.

Here, the case that the to-be-oxidized layer is constituted of one layer in the embodiment has been explained, but similar function and advantage can be obtained when the to-be-oxidized layer is constituted of plural layers. Such a constitution can be adopted that AlₓGa₁₋ₓAs (x≧0.95) with an Al composition ratio larger than that in AlGaAs constituting the semiconductor multi-layer film reflecting mirror 2 is provided between the cladding layer 3 and the semiconductor multi-layer film reflecting mirror 2 instead of the to-be-oxidized layer 32. That is, this constitution means that the to-be-oxidized layer 30 in the first embodiment shown in FIGS. 1 to 9 is provided. In that case, since the to-be-oxidized layer is positioned at a portion relatively deep from a surface of the vertical cavity surface emitting laser diode, such a merit can be obtained that the to-be-oxidized layer is positioned is hardly influenced by proton implantation.

### Fourth Embodiment

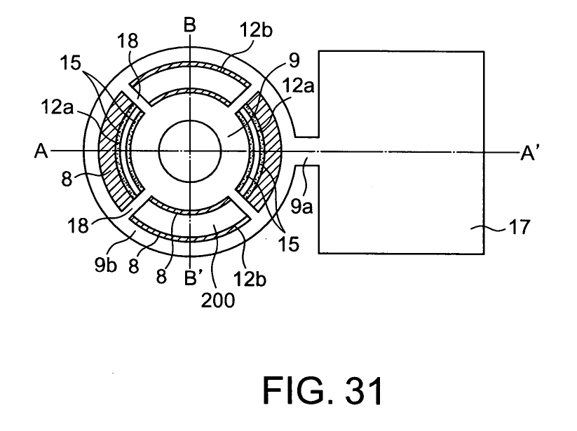

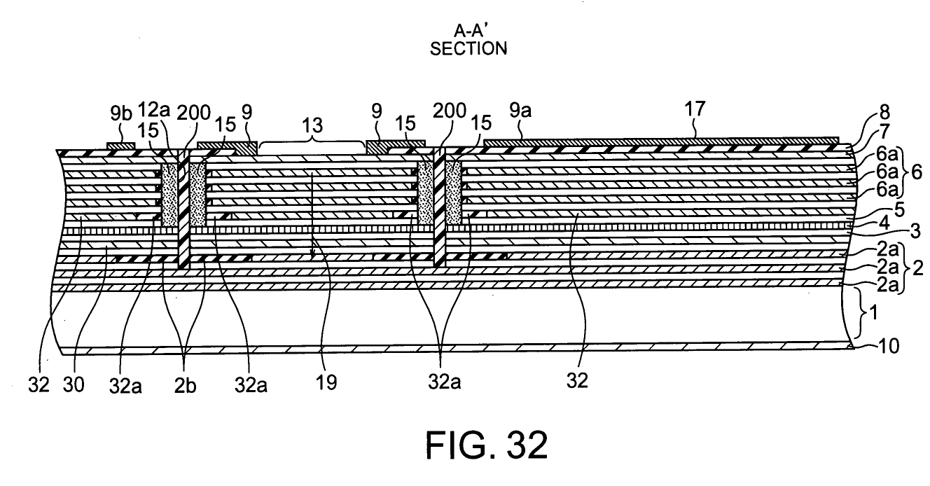

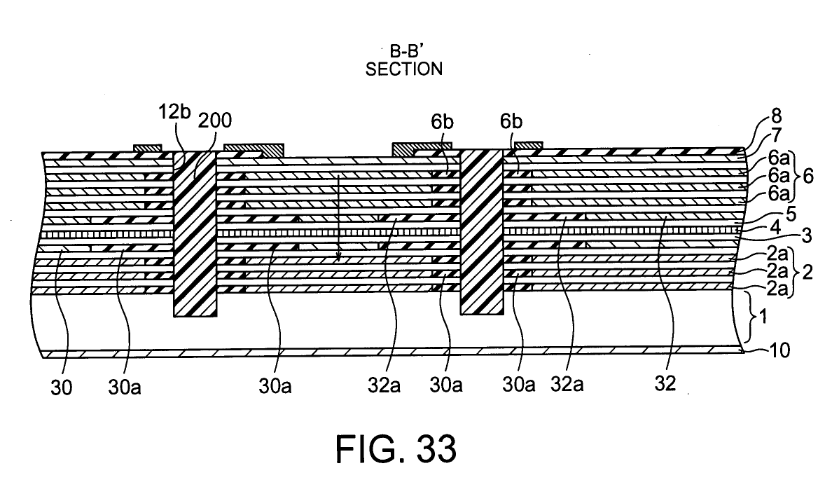

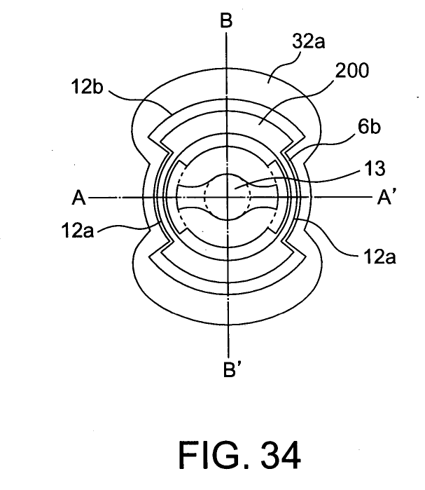

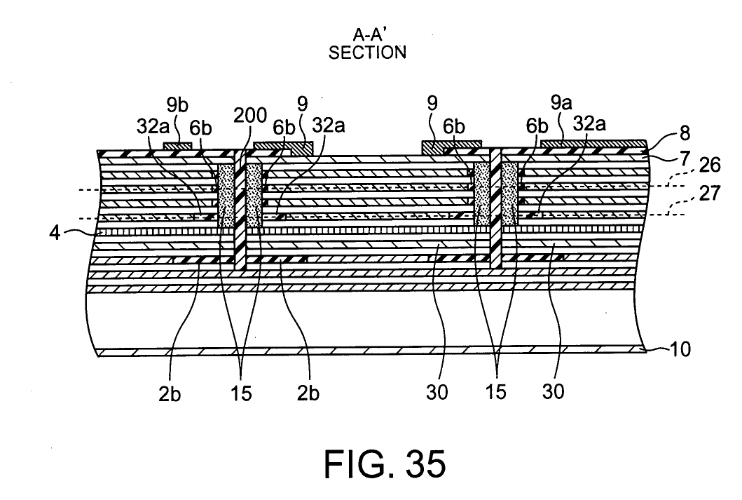

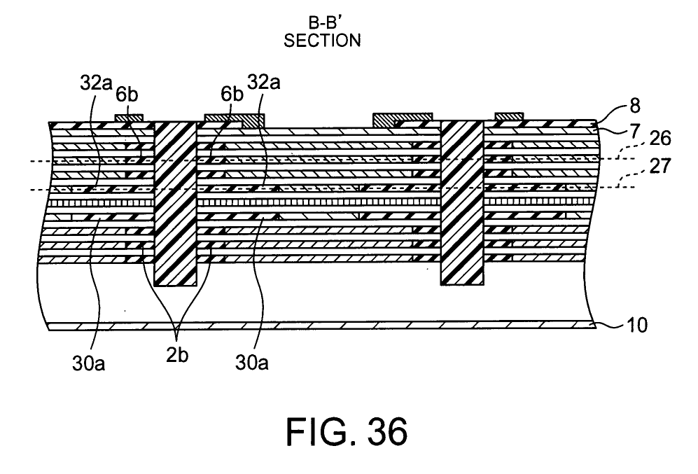

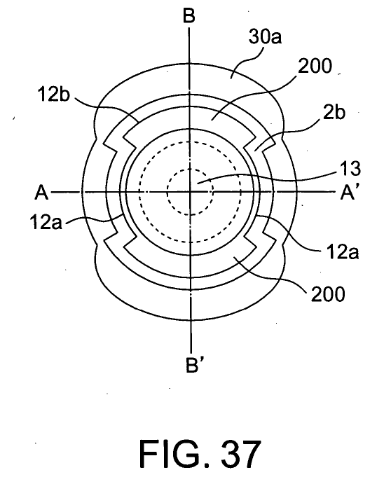

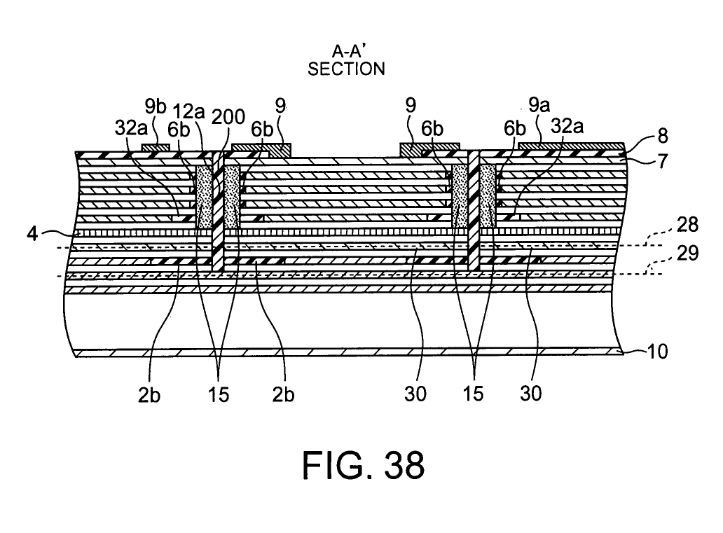

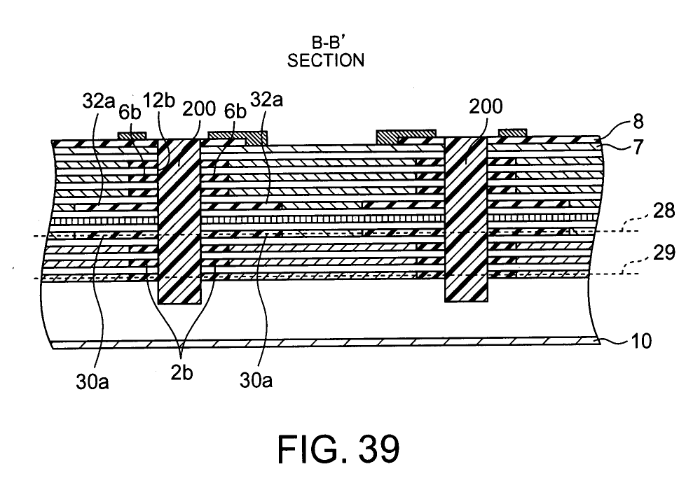

Next, a constitution of a vertical cavity surface emitting laser diode according to a fourth embodiment of the present invention will be explained with reference to FIGS. 31 and 39. FIG. 31 is a plan view of the vertical cavity surface emitting laser diode, FIG. 32 is a sectional view of the vertical cavity surface emitting laser diode taken along A-A′ shown in FIG. 31, and FIG. 33 is a sectional view of the vertical cavity surface emitting laser diode taken along B-B′ shown in FIG. 31. FIG. 34 is a view showing a shape of an oxidized region 6b of a semiconductor multi-layer reflecting mirror 6 of a vertical cavity surface emitting laser diode according to the fourth embodiment obtained when the vertical cavity surface emitting laser diode has been cut at a height 26 (see FIG. 35) thereof and a shape of an oxidized region 32a of an upper to-be-oxidized layer 32 obtained when the vertical cavity surface emitting laser diode has been cut at another height 27 thereof in a superimposing manner, FIG. 35 is a sectional view of the vertical cavity surface emitting laser diode taken along line A-A′ shown in FIG. 34, and FIG. 36 is a sectional view of the vertical cavity surface emitting laser diode taken along line B-B′ shown in FIG. 34. FIG. 37 is a view showing a shape of an oxidized region 30a of a semiconductor multi-layer reflecting mirror 30 of a vertical cavity surface emitting laser diode according to the fourth embodiment obtained when the vertical cavity surface emitting laser diode has been cut at a height 28 thereof and a shape of an oxidized region 2b of an upper to-be-oxidized layer 2 obtained when the vertical cavity surface emitting laser diode has been cut at another height 29 thereof in a superimposing manner, FIG. 38 is a sectional view of the vertical cavity surface emitting laser diode taken along line A-A′ shown in FIG. 37, and FIG. 39 is a sectional view of the vertical cavity surface emitting laser diode taken along line B-B′ shown in FIG. 37.

The vertical cavity surface emitting laser diode according to the embodiment has a structure that the depths of the recesses 12a and 12b are set at different depths and a proton implantation region 15 for controlling an oxidizing rate is provided in only the first semiconductor multi-layer film reflecting mirror 6 in the line A-A′ direction in the vertical cavity surface emitting laser diode according to the first embodiment shown in FIGS. 1 to 9. Thereby, in the Al high concentration layer 6a constituting the first semiconductor multi-layer film reflecting mirror 6 and the to-be-oxidized layer 32 in the proton implantation region 15, an oxidizing rate largely increases in proportion to the proton concentration in vapor oxidation. In the proton implantation region 15, an oxidation length from a side face of the recess is short, so that application of strain to the semiconductor active layer 4 at the center of the mesa portion becomes anisotropic (asymmetric). Here, the oxidized region 6b of the Al high concentration layer 6a in the first semiconductor multi-layer film reflecting mirror 6, the oxidized region 32a of the upper to-be-oxidized layer 32, and the filler film 200 all have asymmetry and they are applied with stress with high asymmetry. Therefore, a very high selectivity with a polarization extinction ratio of 20 dB or more can be obtained, so that laser characteristic excellent in polarization controllability can be obtained.

As the current confinement structure, such a structure is adopted that an oxidation shape spreading in the line A-A′ direction is applied to the to-be-oxidized layer 32, as shown in FIGS. 34 to 36, but a desired confinement shape can be obtained in the lower to-be-oxidized layer 30 where the proton implantation region 15 has not been formed.

In the embodiment, GaₓIn₁₋ₓAs_{y}N_{1-y} (0≦x≦1, 0≦y<1) was used, but various materials such as InGaAlP base material, AlGaAs base material, or InGaAsP base material can be used instead of GaₓIn₁₋ₓAs_{y}N_{1-y} (0≦x≦1, 0≦y≦1).

Various materials can be used as materials for the cladding layers 4 and 5, and the semiconductor multi-layer film reflecting mirrors 2 and 6. For example, a stacked structure of material with a large refractive index which does not include Al and material with a small refracting index may be used as the semiconductor multi-layer film reflecting mirrors 2 and 6 instead of the stacked structure of the AlGaAs layer and the GaAs layer. A combination of materials such as GaInP/GaAs, GaInPAs/GaAs, GaInP/GaInAs, GaInP/GaPAs, GaInP/GaInAs, or GaP/GaInAsN can be used.

As the growth process, a MBE process or the like can be used. In the example, an example of the triple quantum well structure has been shown as the stacked structure, but a structure using another quantum well or the like can be used.

In the embodiment, a circular shape was used as the shape of a desired opening (light emitting region 13), but similar function and advantage can be obtained when a square shape, a rectangular shape, or an oval shape is used, too.

In the embodiment, 1×10¹⁷/cm³ was used as the concentration of proton implanted. However, it is apparent that similar function and advantage can be obtained when proton is implanted at higher or lower concentration too. When proton is implanted at a higher concentration, an oxidation rate of the Al high concentration layer 6a in the semiconductor multi-layer film reflecting mirror 6 containing Al at a high concentration largely lowers and progress of oxidation can be suppressed at a desired position, so that controllability to oxidation length or oxidation shape is elevated, which is desirable. On the other hand, when proton is implanted at a proton concentration higher than a dopant concentration in the semiconductor multi-layer film reflecting mirrors 2 and 6, the proton implantation region becomes high resistance and current hardly flows in the proton implantation region, so that current easily flows in the oxidized region selectively oxidized. Therefore, it is necessary to set positions of the proton implantation region and the upper electrode properly such that current flow is narrowed to the non-oxidized region. It is preferable that the concentration of proton implanted in the proton implantation region 15 is 1×10¹⁸/cm³ or less.

In the embodiment, the Al_{0.98}Ga_{0.02}As layer was used as the to-be-oxidized layer 32 for forming the current confinement portion. However, it is apparent that similar function and advantage can be obtained when an AlAs layer with a high Al composition ratio or AlₓGa₁₋ₓAs (x≧0.95) is used too.

As explained above, according to the respective embodiments of the present invention, a vertical cavity surface emitting laser diode with high polarization controllability and mass productivity can be obtained even when it is fabricated on an ordinary substrate with a plane orientation (100) plane or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A vertical cavity surface emitting laser diode comprising:
a substrate;
a semiconductor active layer which is formed on the substrate and has a light emitting region;
a first reflecting mirror and a second reflecting mirror which sandwich the semiconductor active layer to form an optical cavity in a direction perpendicular to the substrate, the first reflecting mirror having a first semiconductor multi-layer film and being formed on an opposite side of the semiconductor active layer from the substrate, and the second reflecting mirror having a second semiconductor multi-layer and being formed on a side of the substrate to the semiconductor active layer;
a pair of electrodes configured to inject current into the semiconductor active layer;
a first recess which has a first groove depth penetrating at least the semiconductor active layer from the outermost layer of the first reflecting mirror;
a second recess having a second groove depth shallower than the first groove depth;
a mesa portion which is surrounded by the first and second recesses; and
an insulating film which is buried in the first recess.

2. The vertical cavity surface emitting laser diode according to claim 1, wherein, the insulating film is also buried in the second recess.

3. The vertical cavity surface emitting laser diode according to claim 1, further comprising a current confinement portion which is formed between the first reflecting mirror and the second reflecting mirror, and has a first to-be-oxidized layer including Al, side portions of the first to-be-oxidized layer being oxidized and a central portion thereof being non-oxidized.

4. The vertical cavity surface emitting laser diode according to claim 3, wherein the first to-be-oxidized layer of the current confinement portion is different in size of an oxidized region between a direction in which the first recess is provided and a direction in which the second recess is provided.

5. The vertical cavity surface emitting laser diode according to claim 3, wherein the first to-be-oxidized layer is formed on the side of the substrate to the semiconductor active layer.

6. The vertical cavity surface emitting laser diode according to claim 3, wherein the first to-be-oxidized layer is formed on the opposite side of the semiconductor active layer from the substrate.

7. The vertical cavity surface emitting laser diode according to claim 6, wherein the current confinement portion further comprises a second to-be-oxidized layer which includes Al and is formed on the side of the substrate to the semiconductor active layer.

8. The vertical cavity surface emitting laser diode according to claim 7, wherein a central portion of the second to-be-oxidized layer is non-oxidized and side portions thereof are oxidized.

9. The vertical cavity surface emitting laser diode according to claim 1, wherein the mesa portion is provided in the first reflecting mirror with a proton implantation region.

10. The vertical cavity surface emitting laser diode according to claim 1, wherein the insulating film is made from material having a thermal expansion coefficient larger than those of the substrate, the first and second reflecting mirrors, and the semiconductor active layer.

11. The vertical cavity surface emitting laser diode according to claim 1, wherein the insulating film is made from polyimide resin.

12. The vertical cavity surface emitting laser diode according to claim 1, wherein the semiconductor active layer is made from semiconductor material including Ga, IN, and at least one of As and N.

13. A vertical cavity surface emitting laser diode comprising:
a substrate;
a semiconductor active layer which is formed on the substrate and has a light emitting region;
a first reflecting mirror and a second reflecting mirror which sandwich the semiconductor active layer to form an optical cavity in a direction perpendicular to the substrate, the first reflecting mirror having a first semiconductor multi-layer film and being formed on an opposite side of the semiconductor active layer from the substrate, and the second reflecting mirror having a second semiconductor multi-layer and being formed on a side of the substrate to the semiconductor active layer;
a pair of electrodes configured to inject current into the semiconductor active layer;
a first recess which has a first groove depth penetrating at least the semiconductor active layer from the outermost layer of the first reflecting mirror;
a second recess which has a second groove depth substantially equal to the first groove depth and has a size smaller than that of the first recess;
a mesa portion which is surrounded by the first and second recesses; and
an insulating film which is buried in the first recess.

14. The vertical cavity surface emitting laser diode according to claim 13, wherein, the insulating film is also buried in the second recess.

15. The vertical cavity surface emitting laser diode according to claim 13, further comprising a current confinement portion which is formed between the first reflecting mirror and the second reflecting mirror, and has a first to-be-oxidized layer including Al, side portions of the first to-be-oxidized layer being oxidized and a central portion thereof being non-oxidized.

16. The vertical cavity surface emitting laser diode according to claim 15, wherein the first to-be-oxidized layer of the current confinement portion is different in size of an oxidized region between a direction in which the first recess is provided and a direction in which the second recess is provided.

17. The vertical cavity surface emitting laser diode according to claim 15, wherein the first to-be-oxidized layer is formed on the side of the substrate to the semiconductor active layer.

18. The vertical cavity surface emitting laser diode according to claim 15, wherein the first to-be-oxidized layer is formed on the opposite side of the semiconductor active layer from the substrate.

19. The vertical cavity surface emitting laser diode according to claim 18, wherein the current confinement portion further comprises a second to-be-oxidized layer which includes Al and is formed on the side of the substrate to the semiconductor active layer.

20. The vertical cavity surface emitting laser diode according to claim 19, wherein a central portion of the second to-be-oxidized layer is non-oxidized and side portions thereof are oxidized.

21. The vertical cavity surface emitting laser diode according to claim 13, wherein the insulating film is made from material having a thermal expansion coefficient larger than those of the substrate, the first and second reflecting mirrors, and the semiconductor active layer.

22. The vertical cavity surface emitting laser diode according to claim 13, wherein the insulating film is made from polyimide resin.

23. The vertical cavity surface emitting laser diode according to claim 13, wherein the semiconductor active layer is made from semiconductor material including Ga, IN, and at least one of As and N.
